(19) United States
(12) Patent Application Publication
(10) Pub. No.: US 2025/0088892 A1
(43) Pub. Date: Mar. 13, 2025

(54) TECHNOLOGIES FOR COLLECTING DELAY RELATED MEASUREMENTS FROM USER PLANE FUNCTIONS USING TRACES

(71) Applicant: Intel Corporation, Santa Clara, CA (US)

(72) Inventor: Yizhi YAO, Chandler, AZ (US)

(73) Assignee: Intel Corporation, Santa Clara, CA (US)

(21) Appl. No.: 18/935,059

(22) Filed: Nov. 1, 2024

Related U.S. Application Data
(60) Provisional application No. 63/595,599, filed on Nov. 2, 2023.

(51) Int. Cl. H04W 24/10; H04W 24/08; H04W 48/18

(52) U.S. Cl. CPC H04W 24/10; H04W 24/08; H04W 48/18

(57) ABSTRACT

This disclosure describes systems, methods, and devices related to optimized delay measurement. A device may receive a request from a consumer to create a Trace job for collecting delay-related measurements from a User Plane Function (UPF). The device may request a Unified Data Management (UDM) system to create the Trace job. The device may receive a response about a result of the Trace job creation from the UDM. The device may send a response indicating the result of the Trace job creation to the consumer.

### CROSS-REFERENCE TO RELATED PATENT APPLICATION(S)

This application claims the benefit of U.S. Provisional Application No. 63/595,599, filed Nov. 2, 2023, the disclosure of which is incorporated herein by reference as if set forth in full.

### TECHNICAL FIELD

This disclosure generally relates to systems and methods for wireless communications and, more particularly, to m technologies for collecting delay related measurements from user plane functions using traces.

### BACKGROUND

Artificial intelligence (AI) and machine learning (ML) are now widely adopted across industries, proving successful in fields like telecommunications, including mobile networks. While AI/ML techniques are mature, new complementary methods are constantly emerging. As wireless device usage grows, access demands on wireless channels are rising. The Open RAN Alliance (O-RAN) aims to evolve radio access networks, deploying O-RAN based on 3GPP-defined network slicing technologies.

### BRIEF DESCRIPTION OF THE DRAWINGS

FIG. 1 illustrates an example network architecture, in accordance with one or more example embodiments of the present disclosure.

FIGS. 2-5 depict illustrative schematic diagrams for optimized delay measurement, in accordance with one or more example embodiments of the present disclosure.

FIG. 6 schematically illustrates a wireless network, in accordance with one or more example embodiments of the present disclosure.

FIG. 7 illustrates components of a computing device, in accordance with one or more example embodiments of the present disclosure.

FIG. 8 illustrates components of an example cellular network, in accordance with one or more example embodiments of the present disclosure.

FIG. 9 illustrates components of example network deployments, including a next-generation fronthaul (NGF) deployment, in accordance with one or more example embodiments of the present disclosure.

FIG. 10 illustrates components of an example Management Services (MnS) deployment, 1000, in accordance with one or more example embodiments of the present disclosure.

FIG. 11 illustrates components of an example provisioning Management Services (MnS) deployment to support Life Cycle Management (LCM), in accordance with one or more example embodiments of the present disclosure.

FIG. 12 illustrates components of an example functional framework for Machine Learning (ML) and/or Radio Access Network (RAN) intelligence, in accordance with one or more example embodiments of the present disclosure.

FIG. 13 illustrates components of an AI/ML-assisted network deployment, in accordance with one or more example embodiments of the present disclosure.

FIG. 14 illustrates components of an example neural network (NN), in accordance with one or more example embodiments of the present disclosure.

FIG. 15 illustrates components of an example Reinforcement Learning (RL) architecture, in accordance with one or more example embodiments of the present disclosure.

FIG. 16 illustrates a flow diagram of illustrative process for an illustrative optimized delay measurement system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The present disclosure is generally related to wireless communication, cellular networks, cloud computing, edge computing, data centers, network topologies, and communication system implementations, and artificial intelligence (AI)/machine learning (ML) technologies, and in particular, to technologies for collecting measurements from UPF using Trace.

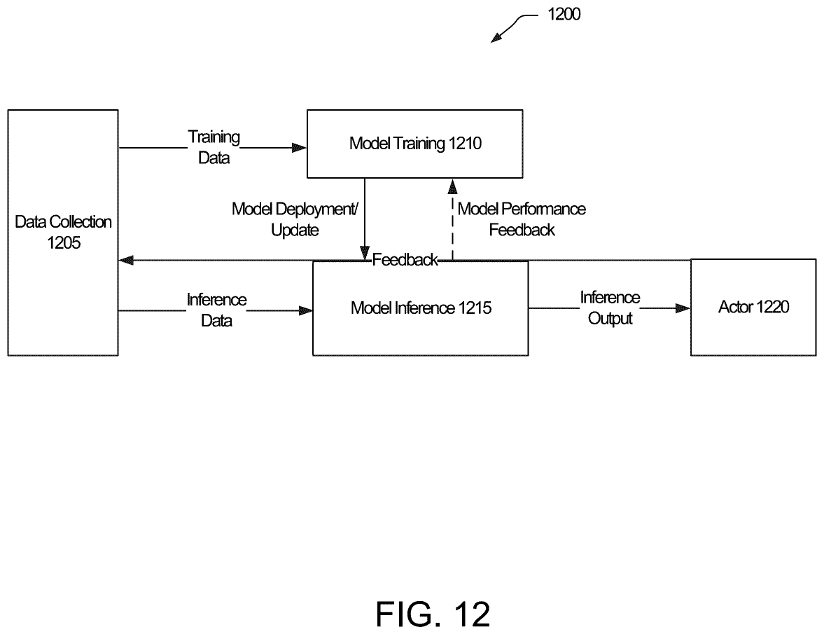

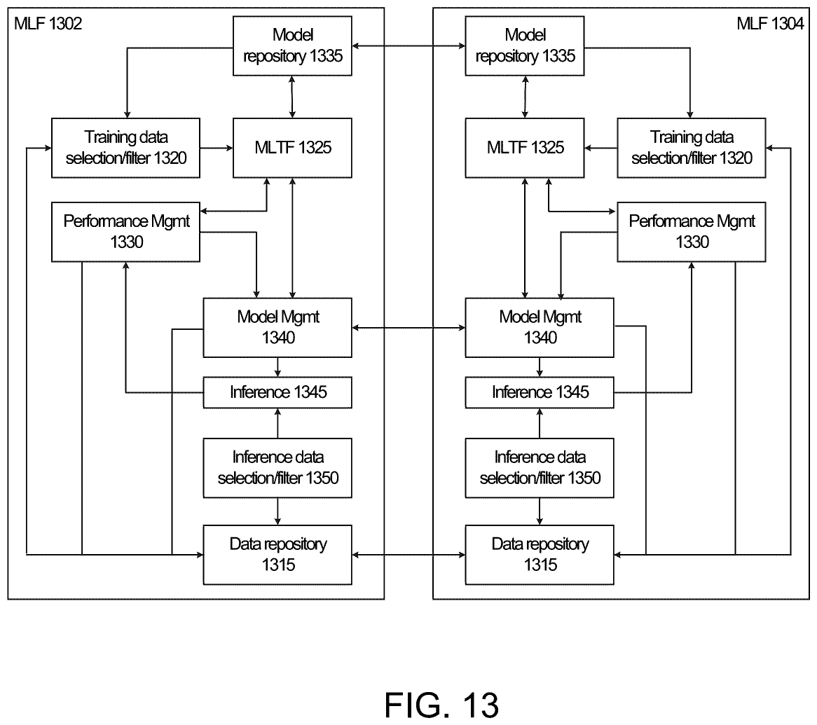

More and more use cases are becoming dependent on the availability of per-UE measurements such as, for example, management control loops (e.g., D-SON, C-SON, hybrid SON, and/or the like) and analytics and intelligence functions in the networks (e.g., NWDAF 162, RAN intelligence functions (see e.g., FIGS. 12-13), and/or the like).

The traditional way of handling per-UE measurements in 3GPP specifications includes trace and minimization of drive-tests (MDT) (see e.g., 3GPP TS 37.320 (“[TS37320]”)), such as measurements are performed either at the UE or at the base station; measurements are performed, collected and reported per UE; measurements are collected and reported using Trace mechanisms (see e.g., 3GPP TS 32.422); and/or measurements used outside of the 3GPP network are subject of user consent and may require anonymization.

The challenges for UE level measurements data collection posed by modern Use Cases across 5GC and NG-RAN are: need to collect per-UE measurements in both NG-RAN and 5GC; no aggregation and/or anonymization should be applied to the collected data in order to maintain its value for various AI/ML data consumers; measurement definitions cannot be limited to RAN only (e.g., not all use cases are RAN-centric); common methodology for per-UE measurements in both NG-RAN and 5GC is needed; the per-UE measurements should be accessible by 3GPP network and management functions and non-3GPP defined functions or entities; and the per-UE measurements need to be easy to consume (i.e., collect and report), by any potential consumers.

Example embodiments of the present disclosure relate to systems, methods, and devices for technologies for Collecting Delay Related Measurements From User Plane Functions Using Traces.

The present disclosure provides technologies and techniques for collecting UE level measurements (e.g., delay related measurements and/or the like) from UPFs using trace and/or MDT mechanisms. The present disclosure includes extensions and/or enhancements to trace/MDT mechanisms to collect UE level measurements from UPF. The UE level measurements can be used to enable AI/ML applications/use cases in the 5GS (e.g., as training data, testing data, validation data, inference data, and/or the like). MDT leverages data from a UE, allowing networks to optimize performance and troubleshoot using data generated during regular device use. This method provides a more comprehensive and real-time view of network performance while saving costs and operational time.

In one or more embodiments, an optimized delay measurement system may be supported by one or more processors and may receive a request from a consumer to initiate a Trace job intended to collect delay-related measurements from the UPF. The optimized delay measurement system may request the UDM to establish the Trace job and may subsequently receive a response from the UDM indicating the Trace job creation outcome, which may then be communicated back to the consumer.

In one or more embodiments, the Trace job may include various trace control and configuration parameters, potentially encompassing SUPI or IMEISV, session IDs such as PDU session ID or N4 session ID, and QoS Flow Identifiers. Additional parameters may include a Trace Reference, a list of NE types for tracing, which may incorporate UPF, and a variety of measurement types. Measurements may comprise one-way DL packet delay between PSA UPF and UE, one-way UL packet delay (with optional exclusion or inclusion of D1) between PSA UPF and UE, two-way packet delay between PSA UPF and UE, and one-way packet delay between PSA UPF and NG-RAN, among other types.

In one or more embodiments, the system may further include specifications for report intervals, IP addresses of the Trace Collection Entity for file-based reporting, or the URI of the Trace Reporting MnS consumer for streaming-based trace reporting, along with a preferred reporting format.

In one or more embodiments, the UDM may propagate trace control and configuration parameters to an AMF, which in turn may relay these parameters to an SMF.

In one or more embodiments, the SMF may receive a request to initiate QoS monitoring for the UE, PDU session, and QoS flow to be measured and may proceed with activating QoS monitoring as required.

In one or more embodiments, the SMF may have received such a QoS monitoring request from a PCF or alternatively from a management function.

In one or more embodiments, once the SMF initiates the QoS monitoring, it may propagate the trace control and configuration parameters to the UPF, which may begin the Trace Session.

In one or more embodiments, the UPF may generate the specified measurements and may optionally initiate a Trace Recording Session.

In one or more embodiments, the UPF may ultimately report the trace data to the TCE.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

The network architecture 100 is designed to support current and future mobile networks, including both LTE and 5G/NR systems, along with other advanced networks that may benefit from the principles described here. At the heart of this network is User Equipment (UE) 102, any device designed to communicate wirelessly, such as a smartphone or IoT device. The UE 102 connects to the Radio Access Network (RAN) 104 through the UU interface, applicable to both LTE and 5G/NR systems. UEs include a broad range of devices, including smartphones, tablets, wearables, drones, and other IoT devices. This versatility ensures network support for applications across industries, enhancing the utility of 100. The network 100 supports direct device-to-device communication, allowing UEs 102 to connect over sidelink (SL) interfaces like ProSe, PC5, and others. This feature bypasses network nodes, improving communication efficiency, particularly for IoT and vehicular systems. Sidelink interfaces (SL), comprising channels such as SBCCH, SCCH, and STCH, and physical channels like PSSCH, PSCCH, PSFCH, PSBCH, enable devices to communicate control and data signals directly. Additionally, UEs can connect to an Access Point (AP) 106, which manages WLAN connections, enabling offloading of some traffic from the RAN 104. This function leverages IEEE 802.11 protocols and cellular-WLAN standards like LWA/LWIP. The RAN 104 encompasses multiple Network Access Nodes (NANs) 114, which provide access to the air interface through protocols like RRC, PDCP, RLC, MAC, and PHY, supporting connectivity for UEs 102. NANs range from macrocells to femtocells and picocells, each providing various coverage capacities tailored to different user densities, ensuring the RAN's flexibility. The NANs 114 take various forms, such as eNodeBs (ENBs) 112, gNodeBs (GNBs) 116, and ng-eNodeBs (ng-eNBs) 118, each playing specific roles in handling radio signals and maintaining UE connectivity. The Central Unit (CU) and Distributed Unit (DU) split structure within NANs 114 allows the CU to handle control while the DU manages radio connections, enhancing network flexibility and scalability. This CU/DU structure enables NANs 114 to deliver distributed processing capabilities, optimizing the network for scenarios requiring high data throughput and reliability. NANs connect through the X2 interface in LTE RAN (E-UTRAN 110) or the XN interface in NG-RAN 114 configurations, facilitating data exchange, mobility, handovers, and load management. The RAN 104 allows for multi-cell connections, where UEs 102 can connect to multiple cells through carrier aggregation, enabling the use of multiple frequencies and improving data throughput. Dual connectivity allows UE 102 to connect to a primary and secondary node, increasing data rate and resilience by distributing traffic dynamically across network resources. The RAN 104 uses both licensed and unlicensed spectrum, incorporating mechanisms like Listen-Before-Talk (LBT) to manage unlicensed band traffic, thus optimizing spectrum usage. UEs 102 share real-time measurement data with NANs 114 or edge compute nodes, providing insight into metrics like signal quality and interference for network optimization. The network's edge computing capabilities enable low-latency data processing, ideal for applications like industrial automation and autonomous vehicles. The Core Network (CN) 120 supports UEs by hosting various Network Functions (NFs), each providing specific roles like session management, authentication, and data routing, ensuring efficient network operation. The Access and Mobility Management Function (AMF) 144 manages UE registration, connection management, and mobility across the network, handling both user and control planes. The Session Management Function (SMF) 146 establishes and manages sessions, including traffic control and Quality of Service (QOS), and coordinates with UPF 148 for data routing. The User Plane Function (UPF) 148 handles packet routing, filtering, and inspection on the user plane, playing a key role in enforcing policies and managing traffic across network paths. The Network Data Analytics Function (NWDAF) 162 collects and analy7es data from NFs and UEs, applying machine learning (ML) to detect patterns, forecast network demand, and improve network efficiency. Policy Control Function (PCF) 156 enforces policy rules, ensuring network operations align with operator-defined policies, and works with Unified Data Management (UDM) 158 for managing subscriber data. The Network Slice Selection Function (NSSF) 150 facilitates network slicing, creating isolated segments for different applications, each with dedicated resources and configurations tailored to specific needs. Network Exposure Function (NEF) 152 securely connects third-party applications with the network, managing access requests and enabling interoperability between external applications and network services. Multi-Access Edge Computing (MEC) and other virtualization technologies support distributed processing, reducing latency and improving response times for applications with high data demands. Edge compute nodes in 100 enhance data processing by providing close-to-source computation, reducing latency, and enabling faster processing for end users. Service-Based Interfaces (SBIs) in 5GC 140 allow NFs to communicate over APIs, supporting seamless interaction across network functions, particularly for control and user planes. Network Repository Function (NRF) 154 maintains NF profiles, including capabilities and services, which facilitates efficient NF discovery and supports dynamic adaptation to network conditions. NWDAF 162 leverages ML algorithms to anal7e data patterns, providing predictive insights into network loads and enhancing resource allocation through data from NFs and UEs. MEC and O-RAN frameworks within the 100 architecture facilitate flexible, low-latency processing, future-proofing the network for new standards and technologies. Vehicle-to-Everything (V2X) communication supports autonomous driving and real-time traffic safety applications, with Roadside Units (RSUs) acting as part of the 100 infrastructure to support data exchanges with vehicles. Network slices in 150 enable prioritization of specific applications, dedicating resources to critical services like emergency communication or automated systems with strict performance requirements. The AMF 144 also provides mobility and registration management for UEs 102, supporting seamless handovers and session continuity as UEs move across the network. Unified Data Management (UDM) 158 stores subscriber information, such as authorization data, through the Unified Data Repository (UDR) 159, which facilitates efficient, consistent data access. Core network interfaces like N1 through N22 provide end-to-end connections across user and control planes, essential for continuous data flows and efficient service delivery. The service-based representation of NFs in 5GC 140 enables function-to-function access through SBIs, supporting flexible interactions across network services. NWDAF 162 in the core supports centralized and distributed analytics. NWDAFs can be configured to specialize in different analytics types, helping tailor insights to specific network areas. Edge Application Server Discovery Function (EASDF) 161 within the CN aids in locating and selecting application servers, essential for services needing real-time processing at the network edge. Data Collection Coordination Function (DCCF) 163 and Analytics Data Repository Function (ADRF) 166 support the collection and analysis of network data, feeding into advanced analytics functions and storage systems like NWDAF 162 for broader data insights.

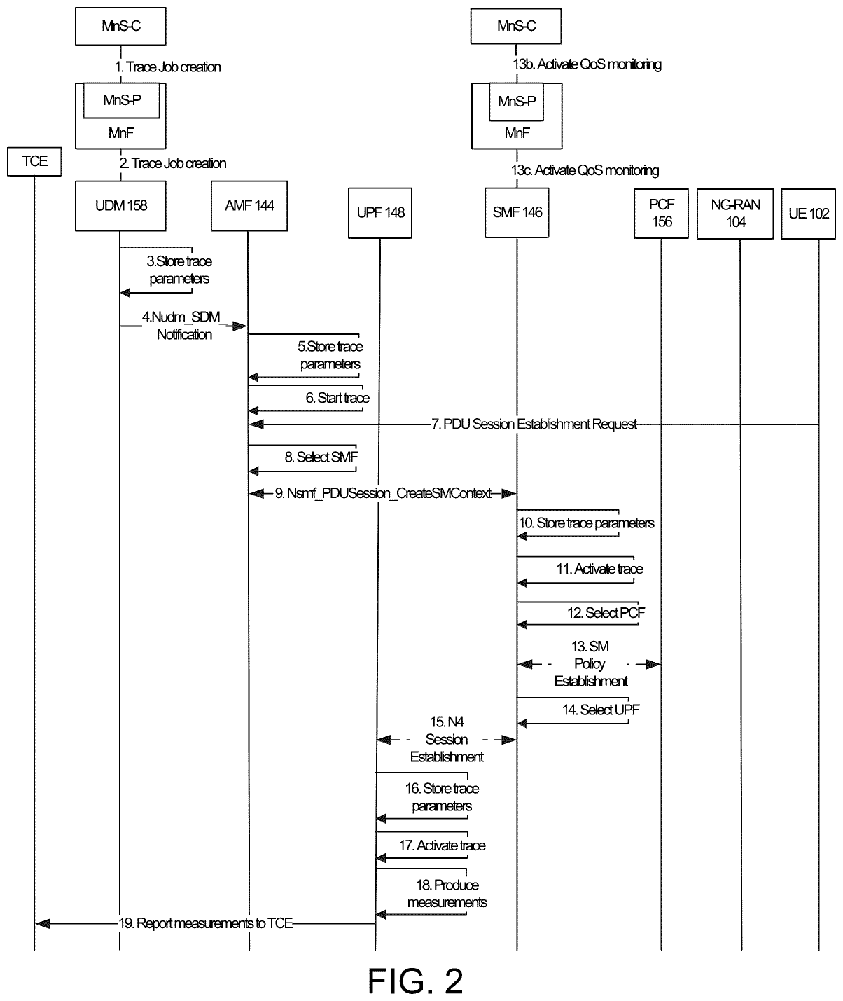

FIGS. 2-5 depict illustrative schematic diagrams for optimized delay measurement, in accordance with one or more example embodiments of the present disclosure.

Trace Control and Configuration Parameters for Collecting Measurements from UPF:

In one or more embodiments, at least one of the following trace control and configuration parameters is included in the Trace Job and/or in the Trace Activation message:
Subscription Permanent Identifier (SUPI), Subscription Concealed Identifier (SUCI), and/or International Mobile Station Equipment Identity and Software Version number (IMEISV).
Session ID (e.g., PDU session ID, N4 session ID, and/or the like).
QoS Flow Identifier (QFI).
Trace Reference.
List of network element (NE) types to trace which includes UPF.
List of measurements. The measurement could be one-way DL packet delay between PSA UPF and UE, one-way UL packet delay (excluding/including D1) between PSA UPF and UE, two-way packet delay between PSA UPF and UE, one-way packet delay between PSA UPF and NG-RAN, etc.
Report Interval.
Network address (e.g., IP address and/or the like) of a Trace Collection Entity (TCE) (also referred to as a “measurement collection entity” or the like) for the file-based trace reporting, and/or a universal resource identifier (URI) of the Trace Reporting MnS-C for the streaming trace reporting.
Trace reporting format.

These parameters can be included in the MDT configuration, or separate from the MDT configuration.

Signaling Trace Session activation procedures for collecting the delay related measurements from UPF.

Referring to FIG. 2, there is shown a Trace activation in 5GC following the PDU Session Establishment procedure

FIG. 2 illustrates an example signaling trace session activation procedure in 5GC as part of the PDU Session Establishment procedure for the UE 102 that has already been registered.

The operations 7, 8, 9, 12, 13 and 15 below are parts of the UE Requested PDU Session Establishment procedure—see [TS23502] § 4.3.2.2 for specific details. The present disclosure does not attempt to re-define how the UE Requested PDU Session Establishment procedure works, but rather illustrates the signaling Trace Activation aspects.
1. Management service consumer requests the MnS-P to create a Trace job (e.g., TraceJob MOI) to collect the measurements from UPF 148.
2. MnF playing the role of MnS-P creates the Trace job on the UDM 158.
3. UDM 158 stores the trace control and configuration parameters received from the management system.
4. UDM 158 sends Nudm_SDM_Notification to AMF 144 with the trace control and configuration parameters information (see e.g., [TS23502] §§ 4.5.1 and 5.2.3.3).
5. AMF 144 stores the trace control and configuration parameters received from the UDM 158.
6. AMF 144 starts the Trace Session according to the received configuration.
7. UE 102 sends PDU Session Establishment request to AMF 144.
8. AMF 144 selects an appropriate SMF 146.
9. AMF 144 sends the Nsmf_PDUSession_CreateSMContext request to the selected SMF 146 with the trace control and configuration parameters.
10. SMF 146 stores the trace control and configuration parameters received from the AMF 144.
11. SMF 146 starts the Trace Session according to the received configuration.
12. SMF 146 selects an appropriate PCF 156.
13. SMF 146 establishes Session Management Policy Association with PCF 156 (see e.g., operation 7 in [TS23502] § 4.3.2.2.1) and provides the trace control and configuration parameters information to the PCF 156.
In this operation, the QoS Monitoring policy is included in the PCC rule for activating the QoS monitoring for the UE 102, PDU session and QoS flow to be measured.
13b. the MnS-C may requests the MnS-P to activate the QoS monitoring for the UE 102, PDU session and QoS flow to be measured.
13c. the MnF playing the role of MnS-P activates the QoS monitoring for the UE 102, PDU session and QoS flow to be measured.

The operations 13b and/or 13c may take place before, after, or simultaneously with operation 13 and/or other operations.
14. SMF 146 selects an appropriate UPF 148.
15. SMF 146 performs N4 Session Establishment with UPF 148 (see e.g., operation 10 in [TS23502] § 4.3.2.2.1) and provides the trace control and configuration parameters information to the UPF 148.
In this operation or after this operation, SMF 146 activates the QoS monitoring on UPF 148.
16. UPF 148 stores the trace control and configuration parameters received from the SMF 146 as part of N4 Session Establishment.
17. UPF 148 starts the Trace Session according to the received configuration.
18. UPF 148 produces the measurement(s) and optionally starts the Trace Recording Session.
19. UPF 148 reports the measurement(s) to TCE.

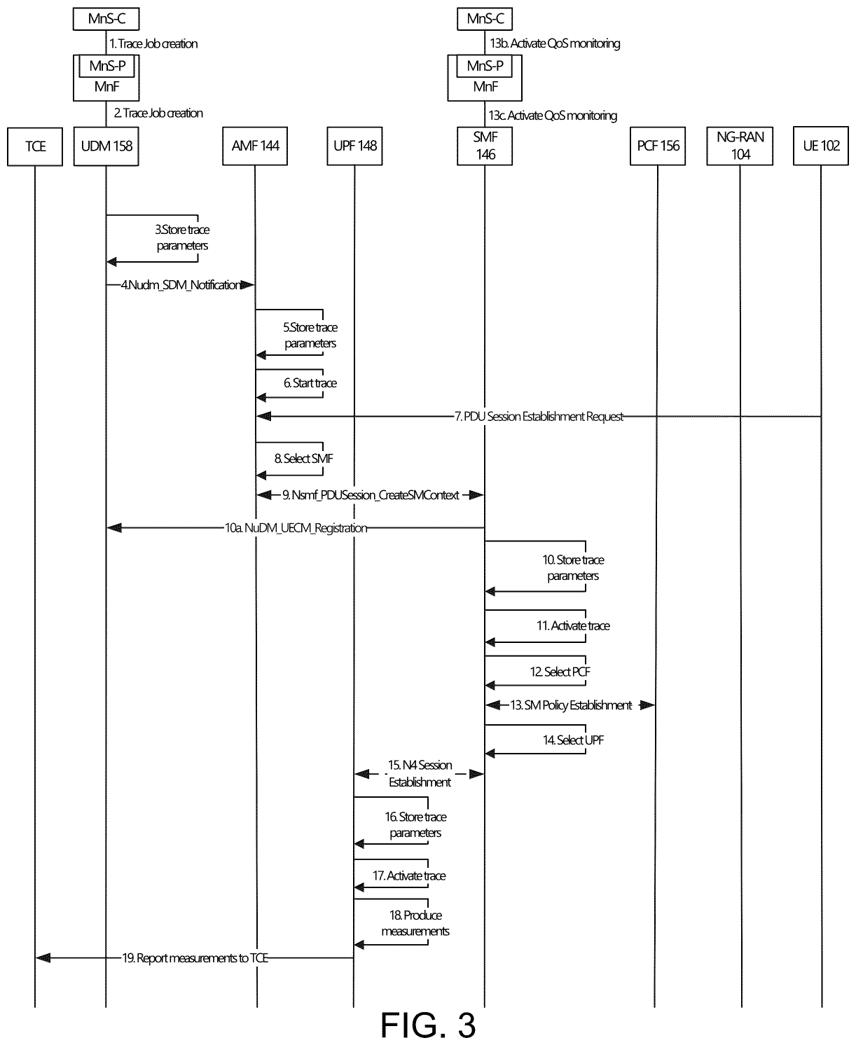

Referring to FIG. 3, there is shown a Trace activation in 5GC following the PDU Session Establishment procedure

FIG. 3 illustrates the signaling Trace Session activation procedure in 5GC 140 as part of the PDU Session Establishment procedure for the UE 102 that has already been registered where SMF 146 obtains trace control and configuration parameters from UDM 158 via Nudm_UECM_Registration procedure.
1. Management service consumer requests the MnS-P to create a Trace job (e.g., TraceJob MOI) to collect the measurements from UPF 148.
2. MnF playing the role of MnS-P creates the Trace job on the UDM 158.
3. UDM 158 stores the trace control and configuration parameters received from the management system.
4. UDM 158 sends Nudm_SDM_Notification to AMF 144 with the trace control and configuration parameters information (see clauses 4.5.1 and 5.2.3.3 of [TS23502]).
5. AMF 144 stores the trace control and configuration parameters received from the UDM 158.
6. AMF 144 starts the Trace Session according to the received configuration.
7. UE 102 sends PDU Session Establishment request to AMF 144
8. AMF 144 selects an appropriate SMF 146.
9. AMF 144 sends the Nsmf_PDUSession_CreateSMContext request to the selected SMF 146 with the trace control and configuration parameters.
10a. SMF 146 performs NuDM_UECM_Registration procedure with UDM 158 and receives the trace control and configuration parameters from UDM 158.
10. SMF 146 stores the trace control and configuration parameters received from the AMF 144.
11. SMF 146 starts the Trace Session according to the received configuration.
12. SMF 146 selects an appropriate PCF 156.
13. SMF 146 establishes Session Management Policy Association with PCF 156 (see operation 7 in clause 4.3.2.2.1 of [TS23502]) and provides the trace control and configuration parameters information to the PCF 156.

In this operation, the QoS Monitoring policy is included in the PCC rule for activating the QoS monitoring for the UE 102, PDU session and QoS flow to be measured.
13b. the MnS-C may requests the MnS-P to activate the QoS monitoring for the UE 102, PDU session and QoS flow to be measured.
13c. the MnF playing the role of MnS-P activates the QoS monitoring for the UE 102, PDU session and QoS flow to be measured.

The operations 13b and/or 13c may take place before, after, or simultaneously with operation 13 and/or other operations.
14. SMF 146 selects an approprite UPF 148.
15. SMF 146 performs N4 Session Establishment with UPF 148 (see operation 10 in [TS23502] § 4.3.2.2.1 of) and provides the trace control and configuration parameters information to the UPF 148.

In this operation or after this operation, SMF 146 activates the QoS monitoring on UPF 148.
16. UPF 148 stores the trace control and configuration parameters received from the SMF 146 as part of N4 Session Establishment.
17. UPF 148 starts the Trace Session according to the received configuration.
18. UPF 148 produces the measurement(s) and optionally starts the Trace Recording Session.
19. UPF 148 reports the measurement(s) to TCE.

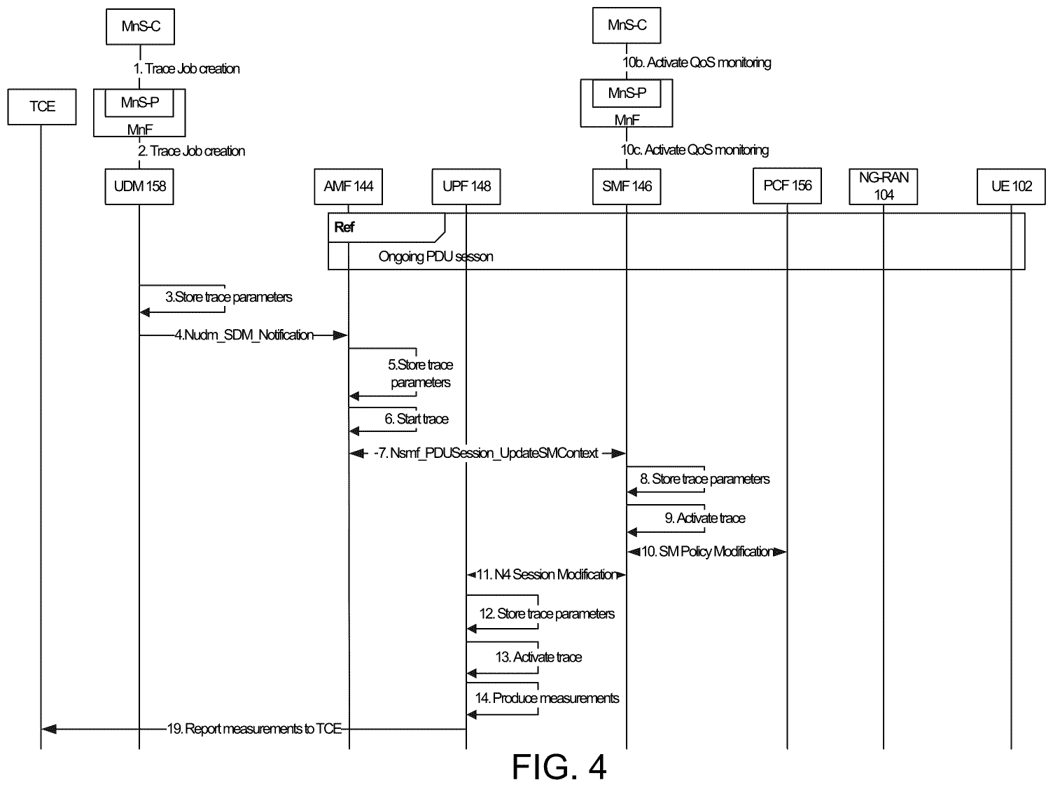

Referring to FIG. 4, there is shown a Trace activation in 5GC following the PDU Session Modification procedure.

FIG. 4 illustrates the signaling Trace Session activation procedure in 5GC as part of the PDU Session Modification procedure for the UE 102 that has already been registered and has an on-going PDU Session.

The operations 6 and 9 infra are parts of the PDU Session Modification procedure (see e.g., [TS23502] § 4.3.3.2 for specific details). The present disclosure does not attempt to re-define how PDU Session Modification procedure works, but rather illustrates the signaling Trace Activation aspects.
1. Management service consumer requests the MnS-P to create a Trace job (e.g., TraceJob MOI) to collect the measurements from UPF 148.
2. MnF playing the role of MnS-P creates the Trace job on the UDM 158.
3. UDM 158 stores the trace control and configuration parameters received from the management system.
4. UDM 158 sends Nudm_SDM_Notification to AMF 144 with the trace control and configuration parameters information (see e.g., [TS23502] §§ 4.5.1 and 5.2.3.3).
5. AMF 144 stores the trace control and configuration parameters received from the UDM 158.
6. AMF 144 activates the Trace Session.
7. AMF 144 sends the Nsmf_PDUSession_UpdateSMContext request to the SMF 146 with the trace control and configuration parameters.
8. SMF 146 stores the trace control and configuration parameters received from the AMF 144.
9. SMF 146 starts the Trace Session according to the received configuration.
10. SMF 146 performs Session Management Policy Modification with PCF 156 (see e.g., operation 7 in [TS23502] § 4.3.3.2) and provides the trace control and configuration parameters information to the PCF 156.

In this operation, the QOS Monitoring policy is included in the PCC rule for activating the QoS monitoring for the UE 102, PDU session and QoS flow to be measured.
10b. the MnS-C may requests the MnS-P to activate the QoS monitoring for the UE 102, PDU session and QoS flow to be measured.
10c. the MnF playing the role of MnS-P activates the QoS monitoring for the UE 102, PDU session and QoS flow to be measured.

The operations 10b and/or 10c may take place before, after, or simultaneously with operation 10 and/or other operations.
11. SMF 146 performs N4 Session Modification with UPF 148 (see e.g., operation 10 in [TS23502] § 4.3.2.2.1) and provides the trace control and configuration parameters information to the UPF 148.

In this operation or after this operation, SMF 146 activates the QoS monitoring on UPF 148.
12. UPF 148 stores the trace control and configuration parameters received from the SMF 146 as part of N4 Session Establishment.
13. UPF 148 starts the Trace Session according to the received configuration.
14. UPF 148 produces the measurement(s) and optionally starts the Trace Recording Session.
15. UPF 148 reports the measurement(s) to TCE.

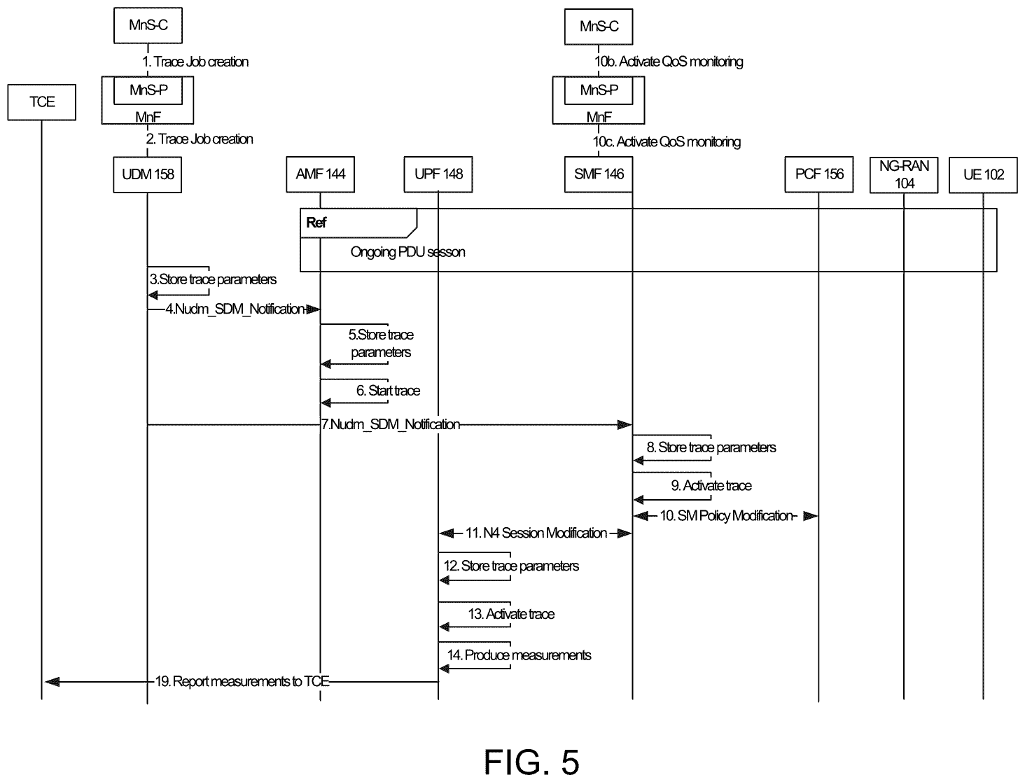

Referring to FIG. 5, there is shown Trace activation in 5GC following the PDU Session Modification procedure (with UDM to SMF notification).

FIG. 5 illustrates the signaling Trace Session activation procedure in 5GC as part of the PDU Session Modification procedure for the UE 102 that has already been registered and has an on-going PDU Session where UDM 158 notifies SMF 146 about trace activation directly.

The operations 6 and 9 infra are parts of the PDU Session Modification procedure (see e.g., [TS23502] § 4.3.3.2 for specific details). The present disclosure does not attempt to re-define how PDU Session Modification procedure works, but rather illustrates the signaling Trace Activation aspects.
1. Management service consumer requests the MnS-P to create a Trace job (e.g., TraceJob MOI) to collect the measurements from UPF 148.
2. MnF playing the role of MnS-P creates the Trace job on the UDM 158.
3. UDM 158 stores the trace control and configuration parameters received from the management system.
4. UDM 158 sends Nudm_SDM_Notification to AMF 144 with the trace control and configuration parameters information (see e.g., [TS23502] §§ 4.5.1 and 5.2.3.3).
5. AMF 144 stores the trace control and configuration parameters received from the UDM 158.
6. AMF 144 activates the Trace Session.
7. UDM 158 sends Nudm_SDM_Notification to SMF 146 with the trace control and configuration parameters information (see e.g., [TS23502] §§ 4.5.2 and 5.2.3.3).
8. SMF 146 stores the trace control and configuration parameters received from the AMF 144.
9. SMF 146 starts the Trace Session according to the received configuration.
10. SMF 146 performs Session Management Policy Modification with PCF 156 (see e.g., operation 7 in [TS23502] § 4.3.3.2) and provides the trace control and configuration parameters information to the PCF 156.

In this operation, the QOS Monitoring policy is included in the PCC rule for activating the QoS monitoring for the UE 102, PDU session and QoS flow to be measured.
10b. the MnS-C may requests the MnS-P to activate the QoS monitoring for the UE 102, PDU session and QoS flow to be measured.
10c. the MnF playing the role of MnS-P activates the QoS monitoring for the UE 102, PDU session and QoS flow to be measured.

The operations 10b and/or 10c may take place before, after, or simultaneously with operation 10 and/or other operations.
11. SMF 146 performs N4 Session Modification with UPF 148 (see e.g., operation 10 in [TS23502] § 4.3.2.2.1) and provides the trace control and configuration parameters information to the UPF 148.

In this operation or after this operation, SMF 146 activates the QoS monitoring on UPF 148.
12. UPF 148 stores the trace control and configuration parameters received from the SMF 146 as part of N4 Session Establishment.
13. UPF 148 starts the Trace Session according to the received configuration.
14. UPF 148 produces the measurement(s) and optionally starts the Trace Recording Session.
15. UPF 148 reports the measurement(s) to TCE.

It is understood that the above descriptions are for the purposes of illustration and are not meant to be limiting.

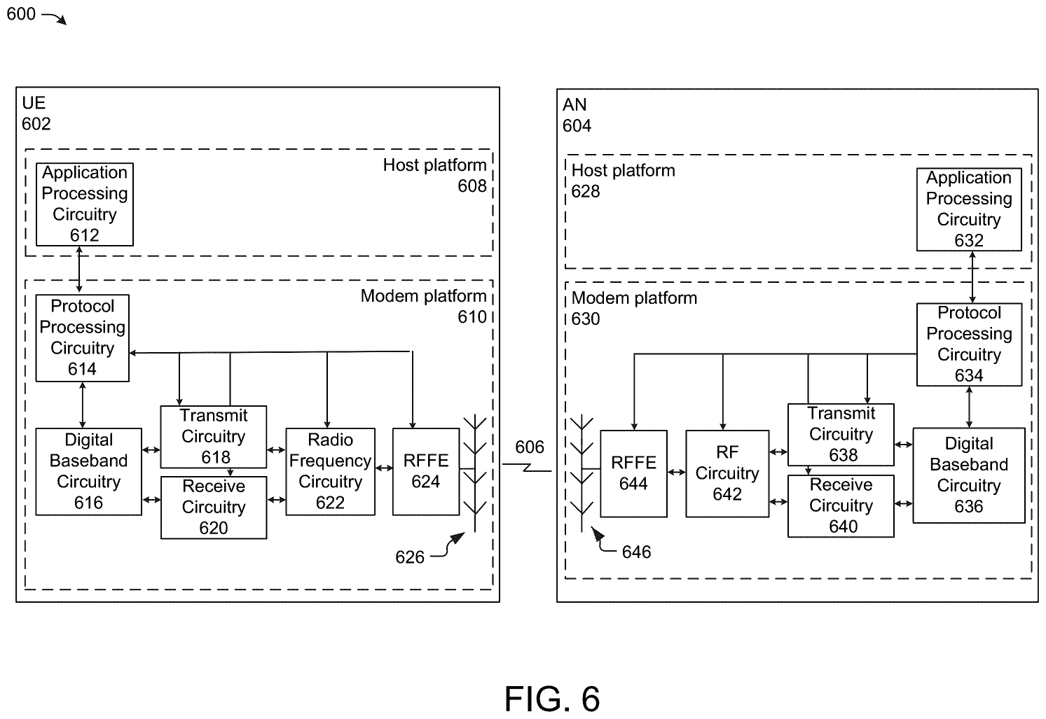

FIG. 6 illustrates an example wireless network architecture 600, featuring a User Equipment (UE) 602 communicatively coupled with a Network Access Node (NAN) 604 through an air interface connection 606. The UE 602 and NAN 604 share functional similarities with the elements UE 102 and NAN 114, respectively, from prior architectures. The air interface connection 606 supports communication in line with cellular standards such as LTE and 5G/New Radio (NR), facilitating interactions over mmWave or sub-6 GHZ frequencies or according to other specified RATs. Within this setup, the UE 602 comprises a host platform 608 linked to a modem platform 610. The host platform 608 includes application processing circuitry 612, which interacts with the protocol processing circuitry 614 on the modem platform 610. The application processing circuitry 612 hosts various applications for sourcing and processing data, operating across transport layers (e.g., UDP, TCP, QUIC) and network layers (e.g., IP) to support data transmissions and receptions.

The protocol processing circuitry 614 on the UE's modem platform 610 manages essential networking layers, such as MAC, RLC, PDCP, RRC, and NAS. In parallel, the modem platform 610 itself incorporates digital baseband circuitry 616, which performs additional layer operations that support the connection 606 below the protocol processing circuitry in the stack. Digital baseband operations include handling PHY layer functions such as HARQ-ACK operations, scrambling/descrambling, encoding/decoding, and modulation symbol mapping. It also supports more advanced operations such as multi-antenna port precoding/decoding, which involves techniques like space-time, space-frequency, and spatial coding, alongside signal reference generation and decoding, preamble and synchronization sequence management, and blind decoding for control channels.

The UE 602 modem platform also includes transmit (Tx) circuitry 618, receive (Rx) circuitry 620, radio frequency (RF) circuitry 622, and RF front-end (RFFE) circuitry 624, all interconnected to one or more antenna panels 626. The Tx circuitry 618 comprises a digital-to-analog converter, mixers, and intermediate frequency components, while the Rx circuitry 620 integrates an analog-to-digital converter, mixers, and other intermediate frequency components. RF circuitry 622 includes a low-noise amplifier, a power amplifier, and power tracking components, while the RFFE 624 contains filters (e.g., surface or bulk acoustic wave filters), switches, antenna tuners, and beamforming components (such as phase-array antennas). Antenna panels 626, also called Tx/Rx components, house various antenna elements-PIFAs, monopole, dipole, loop, patch, Yagi, parabolic dish, and omni-directional antennas, among others. The choice and configuration of these components vary depending on specific operational requirements, such as the frequency range (mmWave or sub-6 GHZ) and transmission mode (TDM or FDM). Tx/Rx components are configured in parallel chains and may reside on different modules or chips, with control provided by circuitry within the protocol processing circuitry 614.

For UE 602 operations, signal reception is managed by the antenna panels 626, which receive transmissions from NAN 604 via the RFFE 624, RF circuitry 622, Rx circuitry 620, digital baseband circuitry 616, and protocol processing circuitry 614. The UE employs receive-beamforming techniques on the antenna panels 626, enabling targeted reception across specific antenna elements. Conversely, for signal transmission, data travels from the protocol processing circuitry 614 through digital baseband circuitry 616, Tx circuitry 618, RF circuitry 622, RFFE 624, and out through antenna panels 626. Tx components apply spatial filtering to transmitted data, generating directional beams emitted from antenna elements on the panels 626.

In parallel to UE 602, the NAN 604 also incorporates a host platform 628 coupled with a modem platform 630. The host platform 628 features application processing circuitry 632 connected to the modem platform's protocol processing circuitry 634. The NAN 604's modem platform 630 also includes components akin to the UE's digital baseband circuitry 636, Tx circuitry 638, Rx circuitry 640, RF circuitry 642, RFFE circuitry 644, and antenna panels 646. These components are substantially similar to those on the UE 602, allowing interchangeability and consistent performance across the network. NAN 604 components are also capable of performing key logical functions, including Radio Network Controller (RNC) responsibilities like radio bearer management, dynamic uplink and downlink resource allocation, and scheduling of data packet transmissions.

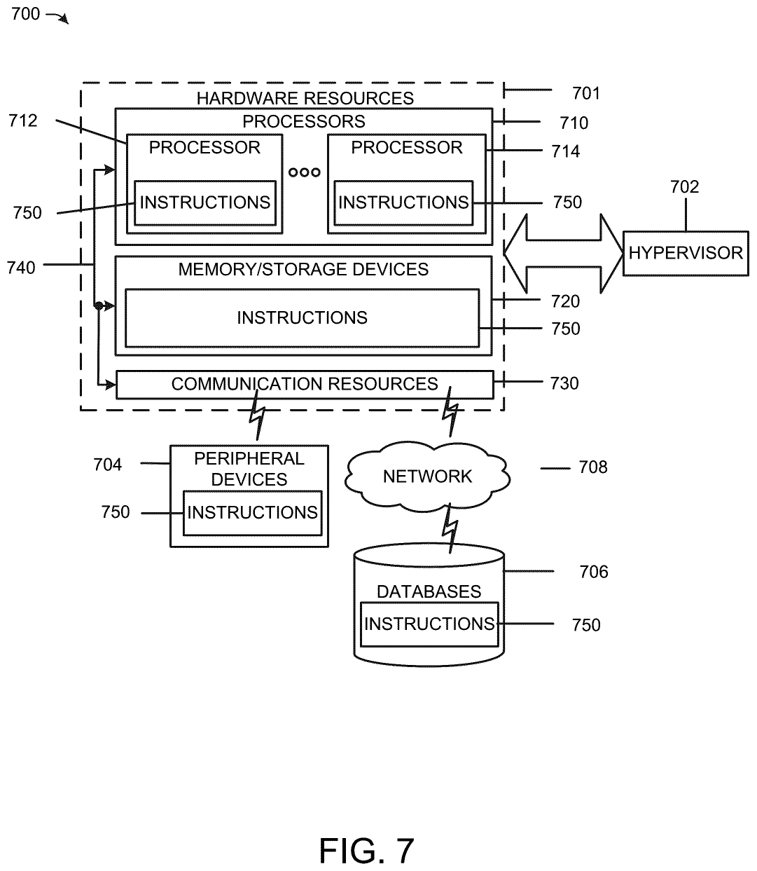

FIG. 7 illustrates components designed to read instructions from a machine-readable or computer-readable medium, such as a non-transitory machine-readable storage medium, and perform one or more methodologies as discussed. Specifically, FIG. 7 displays hardware resources 700 that consist of one or more processors (or processor cores) 710, various memory/storage devices 720, and a range of communication resources 730, all of which may be communicatively linked via a bus 740 or alternative interface circuitry. In virtualized environments (e.g., NFV applications), a hypervisor 702 may be executed to provide an operational environment for network slices or sub-slices, enabling them to leverage the hardware resources 700 efficiently. In some scenarios, these hardware resources 700 may reside within a single compute node housed in an enclosure of variable form factors. In other configurations, the hardware resources 700 may span multiple compute nodes, potentially distributed across data centers or geographical regions.

The processors 710 include a range of processing options, such as processor 712 and processor 714, and may encompass various types including CPUs, RISC or CISC processors, GPUs, DSPs like baseband processors, ASICs, FPGAs, RFICs, and microprocessors or controllers. These processors 710 are capable of supporting a diverse array of computing tasks, from general-purpose to specialized processing, such as ultra-low voltage processing, multi-core and multithreaded computing, and networking functions with processors like DPUs, IPUs, NPUs, or any appropriate combination suited to the application.

Memory and storage devices 720 encompass main memory, disk storage, and other volatile, non-volatile, and semi-volatile memory types. Examples include RAM, SRAM, DRAM, MRAM, CB-RAM, PRAM, ROM, EEPROM, flash memory, and solid-state storage. Additionally, memory/storage devices 720 support technologies like NAND and NOR flash variants (SLC, MLC, QLC, TLC), PCM, NVM with chalcogenide glass, nanowire memory, FeTRAM, MRAM incorporating memristor technology, STT-MRAM, magnetic junction devices, MTJ, and DW/SOT devices, th9istor-based memory, and many others. These elements are essential for maintaining data integrity and providing rapid access for high-speed applications, adaptable for use with various databases, machine learning models, and data-heavy applications.

The communication resources 730 facilitate connections with peripheral devices 704, databases 706, and other network elements via network 708. This communication setup supports wired connections (USB, Ethernet), cellular technologies, NFC, Bluetooth®, Bluetooth® Low Energy, Wi-Fi®, and others, ensuring robust data exchange across devices. The peripheral devices 704 may serve as sensors or actuators, with sensors detecting and sending environmental or state-related data (sensor data) to other devices, modules, or subsystems. Examples of sensors include IMUs with accelerometers, g9oscopes, and magnetometers, MEMS or NEMS (3-12 is accelerometers/g9oscopes), level sensors, flow and temperature sensors, pressure sensors, LiDAR, proximity sensors, depth sensors, and cameras. These sensors allow precise monitoring and feedback to compute nodes or platforms, enhancing interaction with their environments.

Peripheral devices 704 also function as actuators, enabling physical movement or control over machines, systems, or devices, converting energy into motion. Examples include soft actuators, hydraulic/pneumatic actuators, linear actuators, motors, piezoelectric actuators, EMAs, EMRs, SSRs, SMAs, polymer-based actuators, solenoids, impactive mechanisms like jaws or mechanical fingers, and propulsion mechanisms like wheels or 12les. Actuators may also operate in virtualized configurations, permitting digital manipulation of system functions.

The instructions 750 encompass a broad range of executable code types-software, application code, firmware, machine code-designed to trigger specific processing tasks on the processors 710, including those within processor caches and memory/storage devices 720. These instructions may be transmitted from peripheral devices 704 or databases 706 to hardware resources 700 as necessary, stored in caches, memory/storage devices, and other machine-readable media. Depending on the setup, sensors can detect events, such as environmental changes, that trigger responses in other systems, whether exteroceptive (external states), proprioceptive (internal states), or exproprioceptive (linking internal and external data). For instance, peripheral devices may include image sensors, light sensors, ambient sensors, and acoustic sensors, collecting data that enables the processing units to interpret, anal7e, and act upon the surrounding conditions.

Further supporting compute node functionality, the actuators may respond to stimuli by reconfiguring state, position, or orientation, executing tasks such as zoom, focus, or shutdown. In some cases, the actuators integrate with computing elements or controllers like PCHs, memory controllers, and interconnects, dynamically adapting based on operational requirements. These processes rely on instructions 750 from various sources to direct actuator behavior, ensuring the network's components operate within the designated parameters or as environmental changes dictate. Collectively, this configuration of memory, processing, communication, and sensor-actuator systems enables seamless interactions, data management, and robust automation across distributed computing environments.

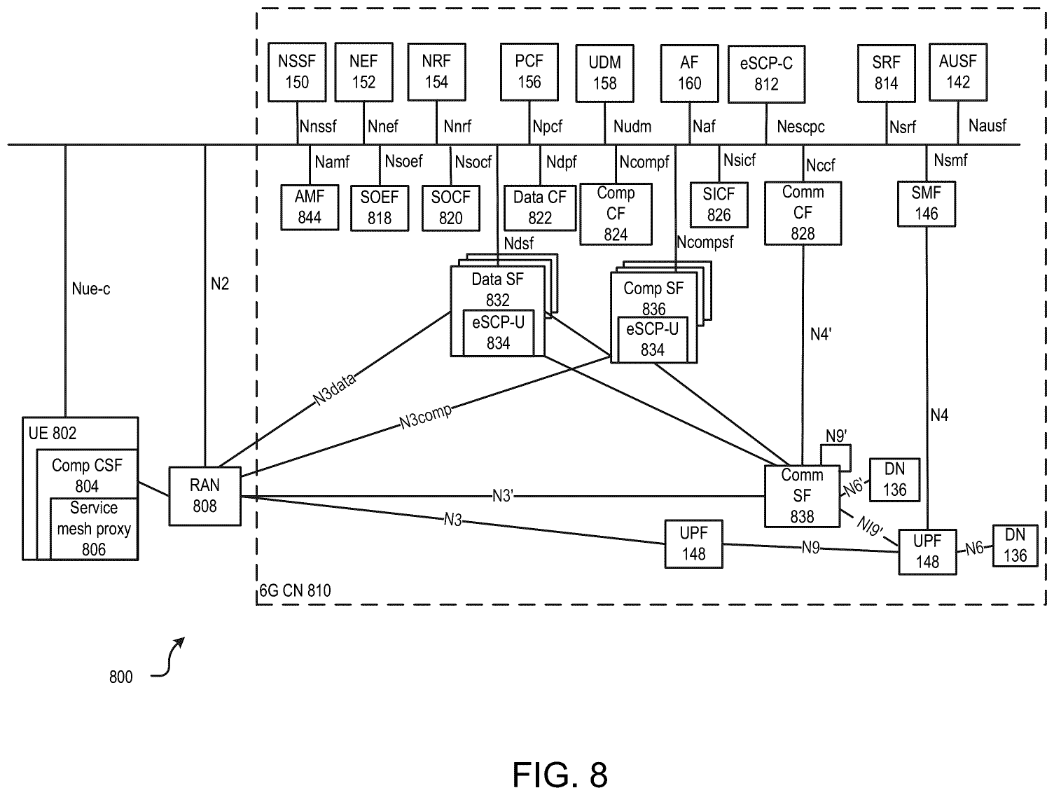

FIG. 8 illustrates an example cellular network 800. The network 800 may operate in a matter consistent with 3GPP technical specifications or technical reports for 6G systems. In some examples, the network 800 may operate concurrently with network 100. For example, in some examples, the network 800 may share one or more frequency or bandwidth resources with network 100. As one specific example, a UE (e.g., UE 802) may be configured to operate in both network 800 and network 100. Such configuration may be based on a UE including circuitry configured for communication with frequency and bandwidth resources of both networks 100 and 800. In general, several elements of network 800 may share one or more characteristics with elements of network 100. For the sake of brevity and clarity, such elements may not be repeated in the description of network 800.

The network 800 may include a UE 802, which may include any mobile or non-mobile computing device designed to communicate with a RAN 808 via an over-the-air connection. The UE 802 may be similar to, for example, UE 102. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, and/or the like.

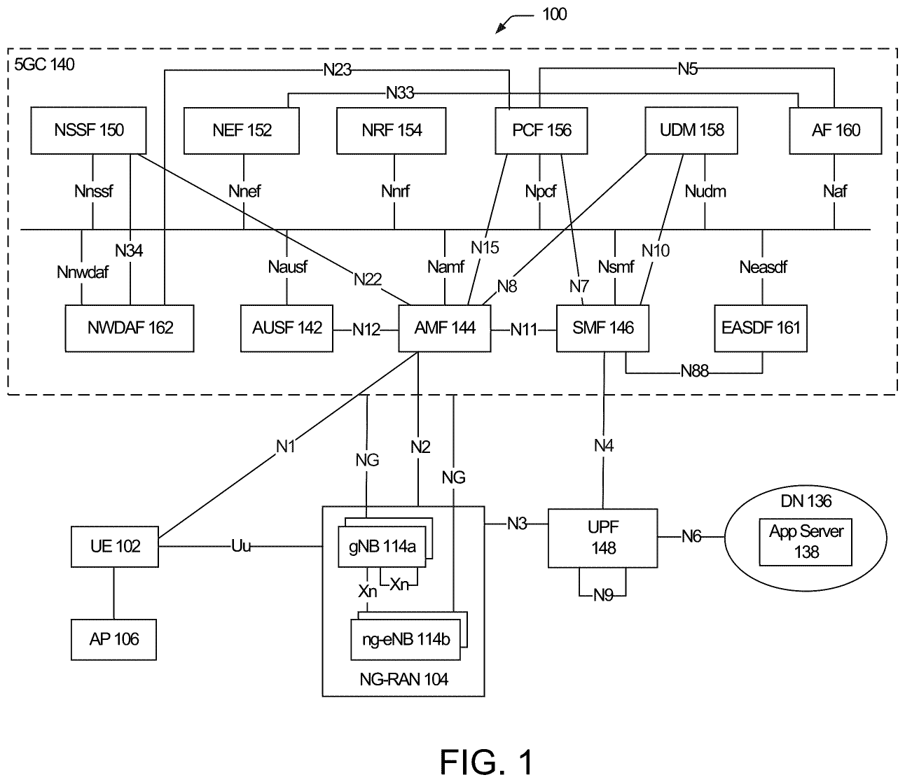

Although not specifically shown in FIG. 8, in some examples the network 800 may include a set of UEs coupled directly with one another via a sidelink interface. The UEs may be M2M/D2D devices that communicate using physical sidelink channels such as, but not limited to, PSBCH, PSDCH, PSSCH, PSCCH, PSFCH, and/or the like. Similarly, although not specifically shown in FIG. 8, the UE 802 may be communicatively coupled with an AP such as AP 106 as described with respect to FIG. 1. Additionally, although not specifically shown in FIG. 8, in some examples the RAN 808 may include one or more ANs such as NAN 114 as described with respect to FIG. 1. The RAN 808 and/or the AN of the RAN 808 may be referred to as a base station (BS), a RAN node, or using some other term or name.

The UE 802 and the RAN 808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 808 may allow for communication between the UE 802 and a 6G core network (CN) 810. Specifically, the RAN 808 may facilitate the transmission and reception of data between the UE 802 and the 6G CN 810. The 6G CN 810 may include various functions such as NSSF 150, NEF 152, NRF 154, PCF 156, UDM 158, AF 160, SMF 146, and AUSF 142. The 6G CN 810 may additional include UPF 148 and DN 136 as shown in FIG. 8.

Additionally, the RAN 808 may include various additional functions that are in addition to, or alternative to, functions of a legacy cellular network such as a 4G or 5G network. Two such functions may include a Compute Control Function (Comp CF) 824 and a Compute Service Function (Comp SF) 836. The Comp CF 824 and the Comp SF 836 may be parts or functions of the Computing Service Plane. Comp CF 824 may be a control plane function that provides functionalities such as management of the Comp SF 836, computing task context generation and management (e.g., create, read, modify, delete), interaction with the underlaying computing infrastructure for computing resource management, and/or the like. Comp SF 836 may be a user plane function that serves as the gateway to interface computing service users (such as UE 802) and computing nodes behind a Comp SF instance. Some functionalities of the Comp SF 836 may include: parse computing service data received from users to compute tasks executable by computing nodes; hold service mesh ingress gateway or service API gateway; service and charging policies enforcement; performance monitoring and telemetry collection, and/or the like. In some examples, a Comp SF 836 instance may serve as the user plane gateway for a cluster of computing nodes. A Comp CF 824 instance may control one or more Comp SF 836 instances.

Two other such functions may include a Communication Control Function (Comm CF) 828 and a Communication Service Function (Comm SF) 838, which may be parts of the Communication Service Plane. The Comm CF 828 may be the control plane function for managing the Comm SF 838, communication sessions creation/configuration/releasing, and managing communication session context. The Comm SF 838 may be a user plane function for data transport. Comm CF 828 and Comm SF 838 may be considered as upgrades of SMF 146 and UPF 148, which were described with respect to a 5G system in FIG. 1. The upgrades provided by the Comm CF 828 and the Comm SF 838 may enable service-aware transport. For legacy (e.g., 4G or 5G) data transport, SMF 146 and UPF 148 may still be used.

Two other such functions may include a Data Control Function (Data CF) 822 and Data Service Function (Data SF) 832 may be parts of the Data Service Plane. Data CF 822 may be a control plane function and provides functionalities such as Data SF 832 management, Data service creation/configuration/releasing, Data service context management, and/or the like. Data SF 832 may be a user plane function and serve as the gateway between data service users (such as UE 802 and the various functions of the 6G CN 810) and data service endpoints behind the gateway. Specific functionalities may include: parse data service user data and forward to corresponding data service endpoints, generate charging data, report data service status.

Another such function may be the Service Orchestration and Chaining Function (SOCF) 820, which may discover, orchestrate and chain up communication/computing/data services provided by functions in the network. Upon receiving service requests from users, SOCF 820 may interact with one or more of Comp CF 824, Comm CF 828, and Data CF 822 to identify Comp SF 836, Comm SF 838, and Data SF 832 instances, configure service resources, and generate the service chain, which could contain multiple Comp SF 836, Comm SF 838, and Data SF 832 instances and their associated computing endpoints. Workload processing and data movement may then be conducted within the generated service chain. The SOCF 820 may also responsible for maintaining, updating, and releasing a created service chain.

Another such function may be the service registration function (SRF) 812, which may act as a registry for system services provided in the user plane such as services provided by service endpoints behind Comp SF 836 and Data SF 832 gateways and services provided by the UE 802. The SRF 812 may be considered a counterpart of NRF 154, which may act as the registry for network functions.

Other such functions may include an evolved service communication proxy (eSCP) and service infrastructure control function (SICF) 826, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 812 and eSCP-U 834, for control plane service communication proxy and user plane service communication proxy, respectively. The SICF 826 may control and configure eCSP instances in terms of service traffic routing policies, access rules, load balancing configurations, performance monitoring, and/or the like.

Another such function is the AMF 844. The AMF 844 may be similar to 144, but with additional functionality. Specifically, the AMF 844 may include potential functional repartition, such as move the message forwarding functionality from the AMF 844 to the RAN 808.

Another such function is the service orchestration exposure function (SOEF) 818. The SOEF may be configured to expose service orchestration and chaining services to external users such as applications.

The UE 802 may include an additional function that is referred to as a computing client service function (comp CSF) 804. The comp CSF 804 may have both the control plane functionalities and user plane functionalities, and may interact with corresponding network side functions such as SOCF 820, Comp CF 824, Comp SF 836, Data CF 822, and/or Data SF 832 for service discovery, request/response, compute task workload exchange, and/or the like. The Comp CSF 804 may also work with network side functions to decide on whether a computing task should be run on the UE 802, the RAN 808, and/or an element of the 6G CN 810.

The UE 802 and/or the Comp CSF 804 may include a service mesh proxy 806. The service mesh proxy 806 may act as a proxy for service-to-service communication in the user plane. Capabilities of the service mesh proxy 806 may include one or more of addressing, security, load balancing, and/or the like.

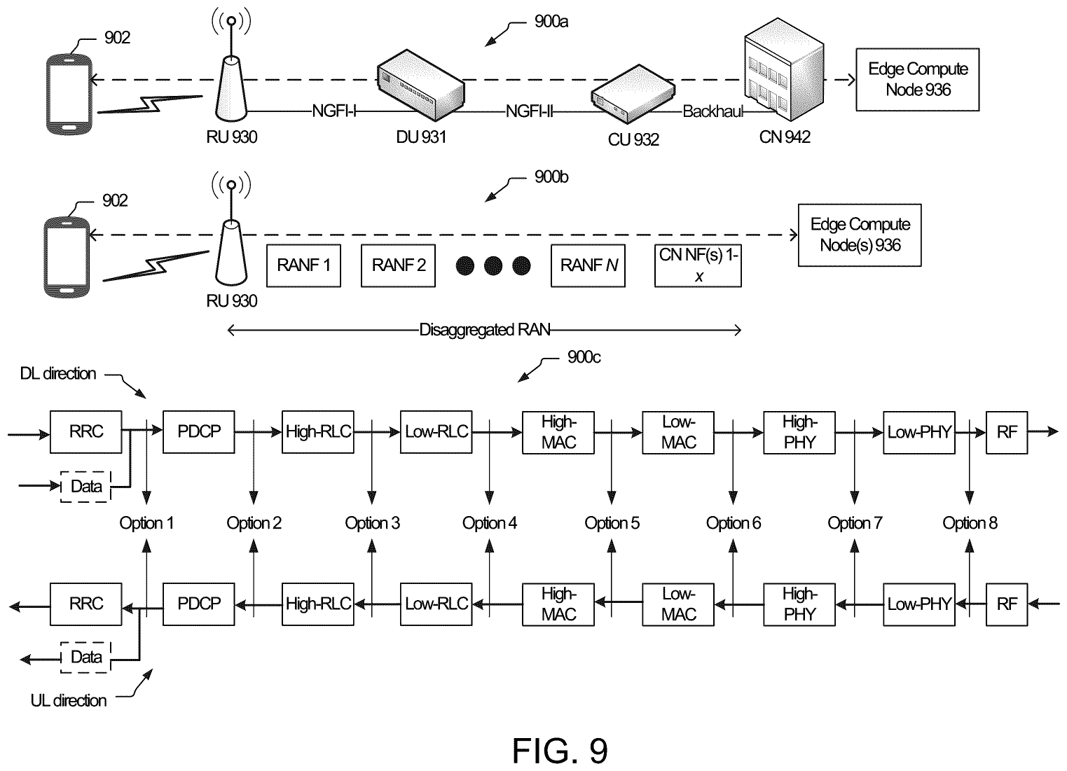

FIG. 9 presents example network deployments, including a next-generation fronthaul (NGF) deployment 900a. In this setup, user equipment (UE) 902 connects to an RU 930, also known as a “remote radio unit 930” or a “remote radio head 930” (RRH 930), through an air interface. The RU 930 links to a Digital Unit (DU) 931 via an NGF interface (NGFI)-I, while the DU 931 connects to a Central Unit (CU) 932 via NGFI-II. Further, the CU 932 communicates with a core network (CN) 942 over a backhaul interface. In 3GPP NG-RAN deployments (e.g., [TS38401]), the DU 931 may be referred to as a distributed unit, with “DU” encompassing both digital and distributed units unless the context specifies otherwise. The UEs 902 may be identical or similar to UE 102, UE 602, hardware resources 700, MLF(s) 1302, 1304, or any other UE described within this context.

Depending on deployment, the NGF setup 900a might follow a distributed RAN (D-RAN) architecture, where the CU 932, DU 931, and RU 930 reside at the cell site, and the CN 942 is centralized. Alternatively, a centralized RAN (C-RAN) architecture is possible, centralizing processing of one or more baseband units (BBUs). In C-RAN deployments, the radio components split, allowing placement in various locations. For example, in some C-RAN setups, only the RU 930 remains at the cell site, while the DU 931, CU 932, and CN 942 are centralized. Other C-RAN configurations may position the RU 930 and DU 931 at the cell site and the CU 932 and CN 942 centrally, or place only the RU 930 at the cell site with the DU 931 and CU 932 at a RAN hub and the CN 942 centralized.

The CU 932 acts as a central controller, interfacing with multiple DUs 931 and RUs 930. As a network node hosting upper layers of a protocol split, the CU 932 supports the radio resource control (RRC), Service Data Adaptation Protocol (SDAP), and Packet Data Convergence Protocol (PDCP) layers within a next-generation NodeB (gNB) or in E-UTRA-NR gNB (en-gNB) implementations. The SDAP layer maps between QoS flows and data radio bearers (DRBs), marking QoS flow IDs (QFIs) in both downlink (DL) and uplink (UL) packets. The PDCP layer manages data transfers, header compression (e.g., ROHC, EHC protocols), encryption, integrity verification, sequence numbering, SDU discard, split bearer routing, duplicate detection, reordering, and orderly delivery. In multiple cases, CU 932 terminates F1 interfaces linked to DUs 931 (e.g., [TS38401]).

A CU 932 can further split into control plane (CP) and user plane (UP) entities, referred to as CU-CP 932 and CU-UP 932, respectively. The CU-CP 932 hosts the RRC and control plane PDCP layers, ending the E1 interface with CU-UP 932 and the F1-C interface with a DU 931. The CU-UP 932 hosts the user plane PDCP and SDAP layers, connecting to the CU-CP 932 via E1 and to a DU 931 via the F1-U interface.

The DU 931 controls radio resources and assigns resources to UEs in real-time. As a network node managing middle to lower layers of the network protocol split, the DU 931, in NG-RAN or O-RAN configurations, hosts the radio link control (RLC), medium access control (MAC), and high-PHY layers of gNB or en-gNB and operates partly under CU 932's supervision. The RLC sublayer supports Transparent, Unacknowledged, and Acknowledged Modes, managing sequence numbering, ARQ error correction, segmentation, reassembly, SDU discard, RLC re-establishment, and error detection. The MAC sublayer handles logical to transport channel mapping, multiplexing, HARQ error correction, scheduling, prioritization, padding, and logical channel management. In some cases, a DU 931 hosts a Backhaul Adaptation Protocol (BAP) layer (e.g., 3GPP TS 38.340) or F1 application protocol (F1AP) and serves as an Integrated Access and Backhaul (IAB) node. DU 931 terminates the F1 interface with CU 932, and may interface with multiple RRHs/RUs 930.

The RU 930, serving as a transmission/reception point, supports radiofrequency processing and may host lower PHY layer functions within NG-RAN and O-RAN frameworks. Its functions include FFT/iFFT, PRACH extraction, and various RF processes. Each CU 932, DU 931, and RU 930 connects via wireless or wired links (e.g., fiber or copper). In some cases, CU 932, DU 931, and RU 930 configurations may parallel RAN 104, NAN 114, AP 106, or other NANs as outlined in the documentation.

An optional fronthaul gateway (FHGW) may reside between DU 931 and RU 930. It links through Open Fronthaul interfaces (e.g., Option 7-2x) or others (e.g., Option 7 or 8) supporting or excluding Open Fronthaul protocols. In some models, a RAN controller connects with CU 932 or DU 931. The NGFI, or “xHaul”, divides RRU 930-BBU connectivity into two levels: level I connecting RU 930 to DU 931 via NGFI-I, and level II connecting DU 931 to CU 932 via NGFI-II, supporting function splits to adjust latency demands and deployment flexibility. NGFI-based architectures include O-RAN 7.2x fronthaul, Enhanced Common Radio Interface (eCPRI), and RoE C-RAN fronthaul interfaces, with further specifications in IEEE1914.1 and related documentation.

In some NGF deployments 900a, a low-level split (LLS) runs between RU 930 and DU 931, deploying Open Fronthaul standards or similar protocols in 3GPP and Small Cell Forum standards. Some CU 932, DU 931, and RU 930 nodes operate as IAB nodes, enabling wireless relays across NG-RAN through a directed acyclic graph (DAG) topology managed by an IAB-donor. Although the NGF deployment 900a typically keeps CU 932, DU 931, RRH 930, and CN 942 distinct, certain implementations integrate these nodes to simplify architecture, combining interfaces like F1-C, F1-U, and E1. Variants include integrating CU 932 and DU 931 into a CU-DU, centralizing CU 932 with DU 931 and RRH 930, or fully integrating CU, DU, and RU with the CN 942.

FIG. 9 additionally highlights a RAN disaggregation setup 900b, where UE 902 connects to RRH 930, which interfaces with disaggregated RAN functions (RANFs) 1−N. Each RANF 1−N may be software elements across geographic segments, operated on physical compute nodes (e.g., COTS HW) with RF circuitry in RRH 930. Disaggregated networking separates SW from HW elements, with APIs facilitating SDN and NF virtualization, enabling modular RANF distribution for flexibility, lower cost, and optimized deployment.

Example RANF disaggregation implementations include RANFs on COTS infrastructure, control/user plane separation, and IEEE802 or O-RAN layers. Disaggregation enables real-time processing (e.g., signal processing algorithms) in lower RAN layers on DUs 931 or RRHs 930 using COTS or purpose-built HW. Functional split options 900c in FIG. 9 illustrate splitting between CU 932 and DU 931, separating non-RT functions like RRC/PDCP from RT layers like RLC, MAC, and PHY. The Option 2 split, placing RRC/PDCP in CU 932 and RLC/MAC/PHY in DU 931, centralizes CU 932 for efficient resource pooling across DUs 931. Other split options vary per deployment requirements and include multiple RANF splits per layer.

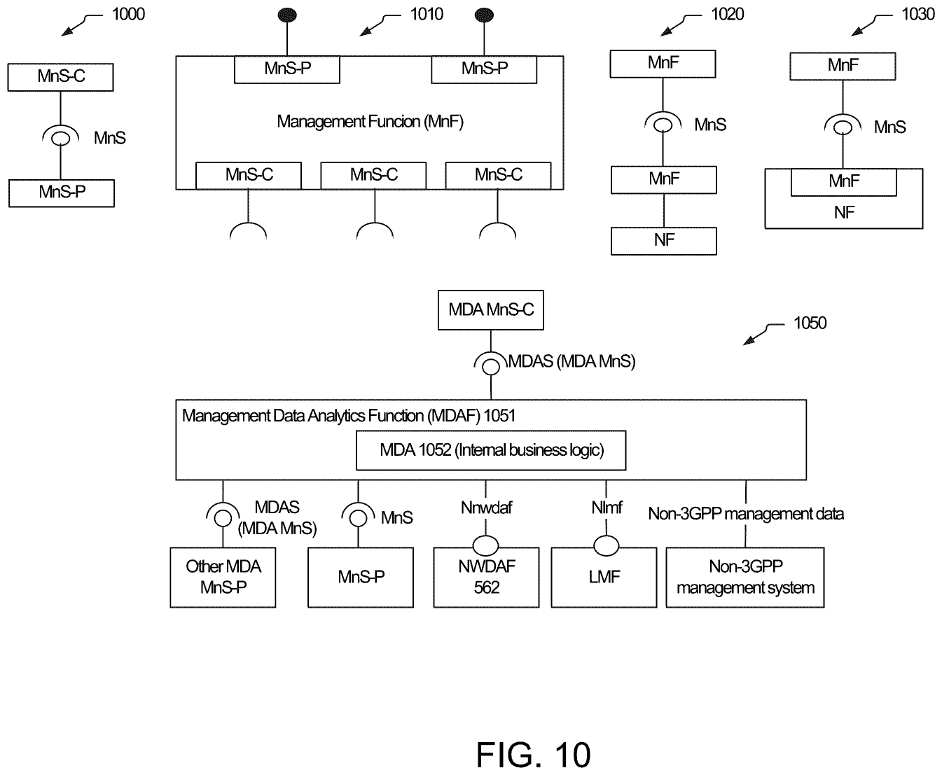

FIG. 10 depicts an example Management Services (MnS) deployment, 1000, utilizing a Service-Based Management Architecture (SBMA). Here, MnS represents a set of management capabilities like network and service orchestration (MANO). MnS producers (MnS-P) offer services consumed by authorized entities (MnS-Cs) through standardized interfaces composed of specified MnS components. Each MnS includes at least two component types: A, B, and C. Component type A consists of general operations and notifications, agnostic to specific network details, such as create, read, update, and delete actions. Component type B, or Network Resource Model (NRM), includes data models for managed entities (e.g., [TS28622]). Component type C provides performance and fault data, covering alarm information (e.g., [TS28532]) and performance metrics ([TS28552], [TS28554]).

The MnS-P profile describes metadata for supported MnS components and optional features. FIG. 10 also illustrates an example management function (MnF) deployment, 1010, where an MnF serves as both MnS-P and MnS-C. This MnF deployment supports exposure governance management, allowing multiple consumers to utilize MnS from MnF 1010. MnFs can be standalone or embedded in a network function (NF), as shown in scenarios 1020 and 1030. MnFs may interact with other MnFs by consuming MnS produced externally.

Another example, MDA service (MDAS or MDA MnS) deployment, 1050, illustrates how management data analytics (MDA) underpins automation and intelligence for network management. MDA processes data, including performance, KPIs, QoE, alarms, and network/service experience data (e.g., AFs 160), to generate analytics like statistics, predictions, and recommendations. MDAS results, consumed by entities like MnFs, NFs, NWDAF 162, SON functions, or human operators, support proactive operations and resource planning. The MDAS leverages SBMA for flexible, authorized analytics requests, aiding consumers like MDAF (MDA MnS-P or MDA MnS-C) and non-3GPP systems in their analytics tasks.

MDA operations anal7e current and historical data (e.g., KPIs per [TS28554], MDT per [TS32422], and QoE data per [TS28405]) alongside external sources like web-based data (AF 160). Outputs, stored as historical reports, serve future analytics. MDAF, acting as a cross-domain MDA MnS-P, may coordinate with entities such as NWDAF 162 and NANs 114 for broader insights ([TS28104]). MDA MnS-Ps offer contextual analytics (e.g., load predictions under various NAN 114 statuses), allowing consumers (MnS-Cs) to integrate this data with network status details for refined decision-making. Due to diverse context needs, MnS-Cs independently gather required network context (see [TS28531]).

MDA processes often use AI/ML functions, and an MDAF may be deployed with AI/ML inferences based on related MDA capabilities. Training for MDA ML entities aligns with [TS28105], supporting AI-enhanced MDA MnS outputs that adapt analytics per network-specific conditions.

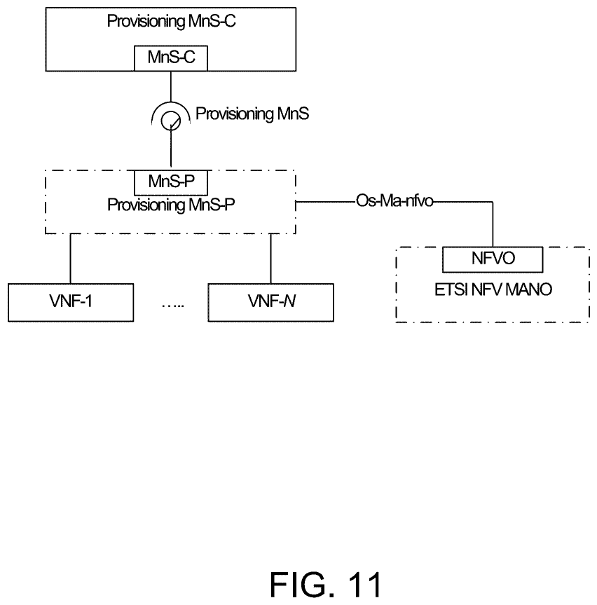

FIG. 11 depicts an example provisioning MnS to support LCM. The 3GPP management system is also capable to consume NFV MANO interface (e.g., Os-Ma-nfvo, Ve-Vnfm-em, and Ve-Vnfm-vnf reference points). An MnS-P can consume management interfaces provided by NFV MANO for at least the following purposes: network service LCM; and VNF LCM, PM, FM, CM on resources supporting VNF. FIG. 11 shows an example framework of provisioning MnS where an MnS-P interfaces to an ETSI NEV MANO to support lifecycle management of VNFs.

Artificial Intelligence and Machine Learning Aspects:

AI/ML is widely used in fifth generation (5G) systems (5GS), including 5G core (5GC) (e.g., Network Data Analytics Function (NWDAF) 162 in FIG. 1), next generation radio access networks (NG-RANs) 104 (e.g., RAN intelligence functions; see e.g., [TS38300] and [TS38401]), and management system (e.g., management data analytics service (MDAS); see e.g., [TS28104], [TS28105], [TR28908], [TS28533], [TS28535], [TS28536], and [TS28550]). Aspects of AI/ML being used in the 5GS are discussed infra.

FIG. 12 depicts an example functional framework 1200 for ML and/or RAN intelligence. The functional framework 1200 includes a data collection function 1205, which is a function that provides input data to the model training function 1210 and model inference function 1215. AI/ML algorithm-specific data preparation (e.g., data pre-processing and cleaning, formatting, and transformation) may or may not be carried out in the data collection function 1205. Examples of input data may include measurements from UEs 1302, RAN nodes 1314, and/or additional or alternative network entities; feedback from actor 1220; and/or output(s) from AI/ML model(s). The input data fed to the model training function 1210 is training data, and the input data fed to the model inference function 1215 is inference data.

The model training function 1210 is a function that performs the AI/ML model training, validation, and testing. The model training function 1210 may generate model performance metrics as part of the model testing procedure and/or as part of the model validation procedure. Examples of the model performance metrics are discussed infra. The model training function 1210 may also be responsible for data preparation (e.g., data pre-processing and cleaning, formatting, and transformation) based on training data delivered by the data collection function 1205, if required.

The model training function 1210 performs model deployment/updates, wherein the model training function 1210 initially deploys a trained, validated, and tested AI/ML model to the model inference function 1215, and/or delivers updated model(s) to the model inference function 1215. Examples of the model deployments and updates are discussed infra.

The model inference function 1215 is a function that provides AI/ML model inference output (e.g., statistical inferences, predictions, decisions, probabilities and/or probability distributions, actions, configurations, policies, data analytics, outcomes, optimizations, and/or the like). The model inference function 1215 may provide model performance feedback to the model training function 1210 when applicable. The model performance feedback may include various performance metrics (e.g., any of those discussed herein) related to producing inferences. The model performance feedback may be used for monitoring the performance of the AI/ML model, when available. The model inference function 1215 may also be responsible for data preparation (e.g., data pre-processing and cleaning, formatting, and transformation) based on inference data delivered by the data collection function 1205, if required.

The model inference function 1215 produces an inference output, which is the inferences generated or otherwise produced when the model inference function 1215 operates the AI/ML model using the inference data. The model inference function 1215 provides the inference output to the actor 1220. Details of inference output are use case specific and may be based on the specific type of AI/ML model being used.

The actor 1220 is a function that receives the inference output from the model inference function 1215, and triggers or otherwise performs corresponding actions based on the inference output. The actor 1220 may trigger actions directed to other entities and/or to itself. In some examples, the actor 1220 is an NES function, a mobility optimization function, and/or a load balancing function. Additionally or alternatively, the inference output is related to NES, mobility optimization, and/or load balancing, and the actor 1220 is one or more RAN nodes 1314 that perform various NES operations, mobility optimization operations, and/or load balancing operations based on the inferences.

The actor 1220 may also provide feedback to the data collection function 1205 for storage. The feedback includes information related to the actions performed by the actor 1220. The feedback may include any information that may be needed to derive training data (and/or testing data and/or validation data), inference data, and/or data to monitor the performance of the AI/ML model and its impact to the network through updating of KPIs, performance counters, and the like.

FIG. 13 presents an AI/ML-assisted network deployment, showing communication between an ML Function (MLF) 1302 and an MLF 1304. AI/ML models enhance over-the-air or wired communication between these MLFs, compatible with 5G/6G standards per 3GPP specifications. Communication mechanisms may integrate with or overlap the components in FIGS. 1, 6, 9, 10, 11, and other specified deployments. In various examples, MLFs 1302 and 1304 may represent MnFs, MnS-Ps, NWDAF service consumers, UEs (e.g., 102, 602), RANs, or individual NFs, and may function independently or share components/entities between them.

Key elements include the Data Repository 1315, which stores collected data (e.g., RAN configurations, KPIs, ML model parameters) and supplies training and inference data. The Training Data Selection/Filter 1320 prepares datasets for ML training, while the ML Training Function (MLTF) 1325 is responsible for model training, validation, and updates, storing results in the Model Repository 1335. Model Management (Mgmt) Function 1340 oversees deployment, monitoring, and model performance based on trained models. The Inference Engine 1345 executes inferences based on input data, providing outcomes like predictions and optimizations. Outputs support network functions such as NES, MRO, and LBO, with performance feedback given to mgmt functions as needed.

Performance Measurement Function 1330 tracks metrics (e.g., accuracy, latency, memory utilization) for deployed models, assessing both model-based metrics (e.g., MAE, recall) and platform-based metrics (e.g., FLOPS, throughput) relevant to the AI/ML model's application across hardware platforms and use cases.

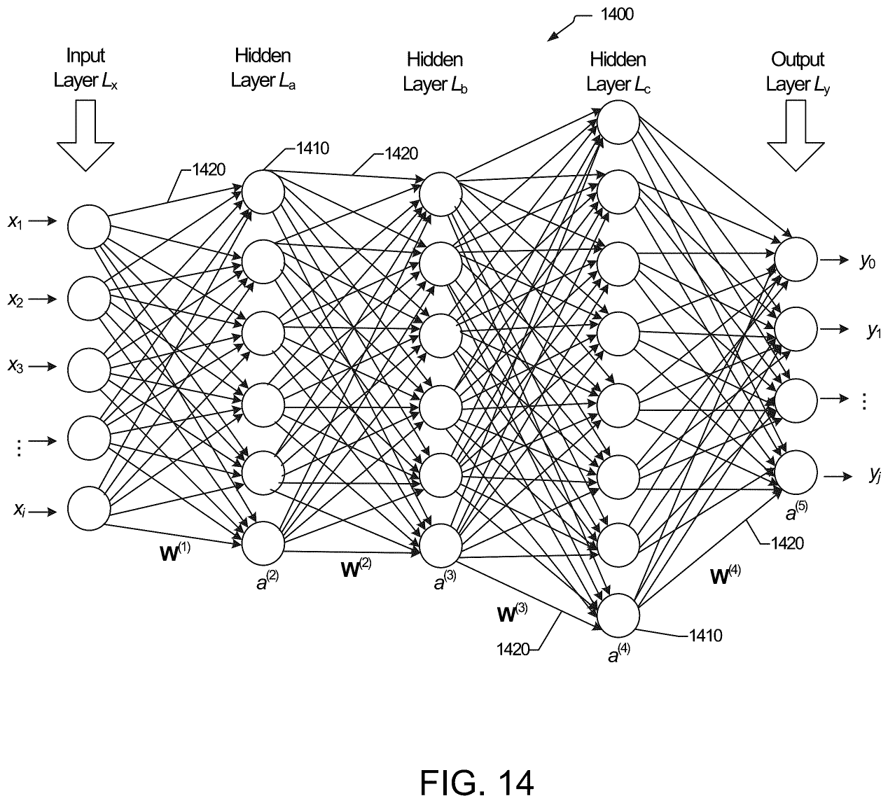

FIG. 14 illustrates an example NN 1400, which may be suitable for use by one or more of the computing systems (or subsystems) of the various implementations discussed herein, implemented in part by a HW accelerator, and/or the like. The NN 1400 may be deep neural network (DNN) used as an artificial brain of a compute node or network of compute nodes to handle very large and complicated observation spaces. Additionally or alternatively, the NN 1400 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 1400 may encompass a variety of ML techniques where a collection of connected artificial neurons 1410 that (loosely) model neurons in a biological brain that transmit signals to other neurons/nodes 1410. The neurons 1410 may also be referred to as nodes 1410, processing elements (PEs) 1410, or the like. The connections 1420 (or edges 1420) between the nodes 1410 are (loosely) modeled on synapses of a biological brain and convey the signals between nodes 1410. Note that not all neurons 1410 and edges 1420 are labeled in FIG. 14 for the sake of clarity.

Each neuron 1410 has one or more inputs and produces an output, which can be sent to one or more other neurons 1410 (the inputs and outputs may be referred to as “signals”). Inputs to the neurons 1410 of the input layer L_x can be feature values of a sample of external data (e.g., input variables x_i). The input variables x_i can be set as a vector containing relevant data (e.g., observations, ML features, and the like). The inputs to hidden units 1410 of the hidden layers L_a, L_b, and L_c may be based on the outputs of other neurons 1410. The outputs of the final output neurons 1410 of the output layer L_y (e.g., output variables y_j) include predictions, inferences, and/or accomplish a desired/configured task. The output variables y_j may be in the form of determinations, inferences, predictions, and/or assessments. Additionally or alternatively, the output variables y_j can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 1410 may have a threshold such that a signal is sent only if the aggregate signal crosses that threshold. A node 1410 may include an activation function, which defines the output of that node 1410 given an input or set of inputs. Additionally or alternatively, a node 1410 may include a propagation function that computes the input to a neuron 1410 from the outputs of its predecessor neurons 1410 and their connections 1420 as a weighted sum. A bias term can also be added to the result of the propagation function.

The NN 1400 also includes connections 1420, some of which provide the output of at least one neuron 1410 as an input to at least another neuron 1410. Each connection 1420 may be assigned a weight that represents its relative importance. The weights may also be adjusted as learning proceeds. The weight increases or decreases the strength of the signal at a connection 1420.

The neurons 1410 can be aggregated or grouped into one or more layers L where different layers L may perform different transformations on their inputs. In FIG. 14, the NN 1400 comprises an input layer Lx, one or more hidden layers Lₐ, L_{b}, and L_{c}, and an output layer L_{y} (where a, b, c, x, and y may be numbers), where each layer L comprises one or more neurons 1410. Signals travel from the first layer (e.g., the input layer L₁), to the last layer (e.g., the output layer L_{y}), possibly after traversing the hidden layers Lₐ, L_{b}, and L-multiple times. In FIG. 14, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 14, for simplicity of illustration, there are only three hidden layers Lₐ, L_{b}, and L_{c} in the NN 1400, however, the NN 1400 may include many more (or fewer) hidden layers Lₐ, L_{b}, and L_{c} than are shown.

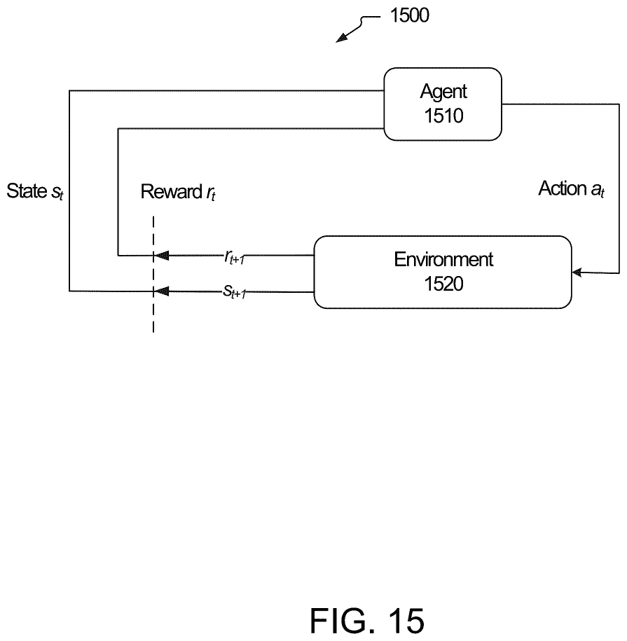

FIG. 15 shows an RL architecture 1500 comprising an agent 1510 and an environment 1520. The agent 1510 (e.g., software agent or AI agent) is the learner and decision maker, and the environment 1520 comprises everything outside the agent 1510 that the agent 1510 interacts with. The environment 1520 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

RL is a goal-oriented learning based on interaction with environment. RL is an ML paradigm concerned with how software agents (or AI agents) ought to take actions in an environment in order to maximize a numerical reward signal. In general, RL involves an agent taking actions in an environment that is/are interpreted into a reward and a representation of a state, which is then fed back into the agent. In RL, an agent aims to optimize a long-term objective by interacting with the environment based on a trial and error process. In many RL algorithms, the agent receives a reward in the next time step (or epoch) to evaluate its previous action. Examples of RL algorithms include Markov decision process (MDP) and Markov chains, associative RL, inverse RL, safe RL, Q-learning, multi-armed bandit learning, and deep RL.

The agent 1510 and environment 1520 continually interact with one another, wherein the agent 1510 selects actions A to be performed and the environment 1520 responds to these Actions and presents new situations (or states S) to the agent 1510. The action A comprises all possible actions, tasks, moves, and/or the like, that the agent 1510 can take for a particular context. The state S is a current situation such as a complete description of a system, a unique configuration of information in a program or machine, a snapshot of a measure of various conditions in a system, and/or the like. In some implementations, the agent 1510 selects an action A to take based on a policy π. The policy π is a strategy that the agent 1510 employs to determine next action A based on the current state S. The environment 1520 also gives rise to rewards R, which are numerical values that the agent 1510 seeks to maximize over time through its choice of actions.

The environment 1520 starts by sending a state St to the agent 1510. In some implementations, the environment 1520 also sends an initial a reward Rt to the agent 1510 with the state St. The agent 1510, based on its knowledge, takes an action At in response to that state St, (and reward Rt, if any). The action At is fed back to the environment 1520, and the environment 1520 sends a state-reward pair including a next state St+1 and reward Rt+1 to the agent 1510 based on the action At. The agent 1510 will update its knowledge with the reward Rt+1 returned by the environment 1520 to evaluate its previous action(s). The process repeats until the environment 1520 sends a terminal state S, which ends the process or episode. Additionally or alternatively, the agent 1510 may take a particular action A to optimize a value V. The value V an expected long-term return with discount, as opposed to the short-term reward R. Vπ(S) is defined as the expected long-term return of the current state S under policy π.

Q-learning is a model-free RL algorithm that learns the value of an action in a particular state. Q-learning does not require a model of an environment 1520, and can handle problems with stochastic transitions and rewards without requiring adaptations. The “Q” in Q-learning refers to the function that the algorithm computes, which is the expected reward(s) for an action A taken in a given state S. In Q-learning, a Q-value is computed using the state St and the action At time t using the function Qπ(St, At). Qπ(St, At) is the long-term return of a current state S taking action A under policy π. For any finite MDP (FMDP), Q-learning finds an optimal policy π in the sense of m12imizing the expected value of the total reward over any and all successive steps, starting from the current state S. Additionally, examples of value-based deep RL include Deep Q-Network (DQN), Double DQN, and Dueling DQN. DQN is formed by substituting the Q-function of the Q-learning by an artificial neural network (ANN) such as a convolutional neural network (CNN).

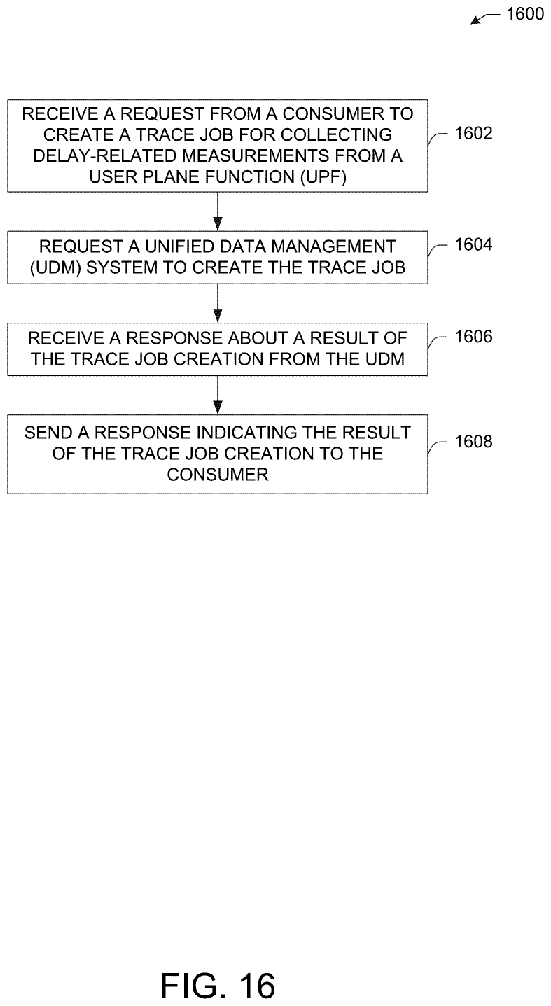

In some embodiments, the electronic device(s), network(s), system(s), chip(s) or component(s), or portions or implementations thereof, may be configured to perform one or more processes, techniques, or methods as described herein, or portions thereof. One such process is depicted in FIG. 16.

For example, the process may include, at 1602, receiving a request from a consumer to create a Trace job for collecting delay-related measurements from a User Plane Function (UPF).

The process further includes, at 1604, requesting a Unified Data Management (UDM) system to create the Trace job.

The process further includes, at 1606, receiving a response about a result of the Trace job creation from the UDM.

The process further includes, at 1608, sending a response indicating the result of the Trace job creation to the consumer.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include a device comprising processing circuitry coupled to storage, the processing circuitry configured to: receive a request from a consumer to create a Trace job for collecting delay-related measurements from a User Plane Function (UPF); request a Unified Data Management (UDM) system to create the Trace job; receive a response about a result of the Trace job creation from the UDM; and send a response indicating the result of the Trace job creation to the consumer.

Example 2 may include the device of example 1 and/or some other example herein, wherein the Trace job may include at least one trace control and configuration parameter selected from the group consisting of a Subscription Permanent Identifier (SUPI), International Mobile

Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

Example 3 may include the device of example 1 and/or some other example herein, the UDM propagates the trace control and configuration parameters to an Access and Mobility Management Function (AMF).

Example 4 may include the device of example 3 and/or some other example herein, wherein the AMF propagates the trace control and configuration parameters to a Session Management Function (SMF).

Example 5 may include the device of example 4 and/or some other example herein, wherein the SMF activates Quality of Service (QOS) monitoring for a User Equipment (UE), Packet Data Unit (PDU) session, and QoS flow to be measured.

Example 6 may include the device of example 5 and/or some other example herein, wherein the SMF receives the request to activate QoS monitoring from a Policy Control Function (PCF).

Example 7 may include the device of example 5 and/or some other example herein, wherein the SMF receives the request to activate QoS monitoring from a management function.

Example 8 may include the device of example 5 and/or some other example herein, wherein the SMF propagates the trace control and configuration parameters to a UPF.

Example 9 may include the device of example 8 and/or some other example herein, wherein the UPF starts a Trace Session.

Example 10 may include the device of example 9 and/or some other example herein, wherein the UPF produces the measurements and optionally starts a Trace Recording Session.

Example 11 may include the device of example 10 and/or some other example herein, wherein the UPF reports the produced measurements to the TCE.

Example 12 may include a non-transitory computer-readable medium storing computer-executable instructions which when executed by one or more processors result in performing operations comprising: receiving a request from a consumer to create a Trace job for collecting delay-related measurements from a User Plane Function (UPF); requesting a Unified Data Management (UDM) system to create the Trace job; receiving a response about a result of the Trace job creation from the UDM; and sending a response indicating the result of the Trace job creation to the consumer.

Example 13 may include the non-transitory computer-readable medium of example 12 and/or some other example herein, wherein the Trace job may include at least one trace control and configuration parameter selected from the group consisting of a Subscription Permanent Identifier (SUPI), International Mobile Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

Example 14 may include the non-transitory computer-readable medium of example 12 and/or some other example herein, the UDM propagates the trace control and configuration parameters to an Access and Mobility Management Function (AMF).

Example 15 may include the non-transitory computer-readable medium of example 14 and/or some other example herein, wherein the AMF propagates the trace control and configuration parameters to a Session Management Function (SMF).

Example 16 may include the non-transitory computer-readable medium of example 15 and/or some other example herein, wherein the SMF activates Quality of Service (QOS) monitoring for a User Equipment (UE), Packet Data Unit (PDU) session, and QoS flow to be measured.

Example 17 may include the non-transitory computer-readable medium of example 16 and/or some other example herein, wherein the SMF receives the request to activate QoS monitoring from a Policy Control Function (PCF).

Example 18 may include the non-transitory computer-readable medium of example 16 and/or some other example herein, wherein the SMF receives the request to activate QoS monitoring from a management function.

Example 19 may include the non-transitory computer-readable medium of example 16 and/or some other example herein, wherein the SMF propagates the trace control and configuration parameters to a UPF.

Example 20 may include the non-transitory computer-readable medium of example 19 and/or some other example herein, wherein the UPF starts a Trace Session.

Example 21 may include the non-transitory computer-readable medium of example 20 and/or some other example herein, wherein the UPF produces the measurements and optionally starts a Trace Recording Session.

Example 22 may include the non-transitory computer-readable medium of example 21 and/or some other example herein, wherein the UPF reports the produced measurements to the TCE.

Example 23 may include a method comprising: receiving a request from a consumer to create a Trace job for collecting delay-related measurements from a User Plane Function (UPF); requesting a Unified Data Management (UDM) system to create the Trace job; receiving a response about a result of the Trace job creation from the UDM; and sending a response indicating the result of the Trace job creation to the consumer.

Example 24 may include the method of example 23 and/or some other example herein, wherein the Trace job may include at least one trace control and configuration parameter selected from the group consisting of a Subscription Permanent Identifier (SUPI), International Mobile Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

Example 25 may include the method of example 23 and/or some other example herein, the UDM propagates the trace control and configuration parameters to an Access and Mobility Management Function (AMF).

Example 26 may include the method of example 25 and/or some other example herein, wherein the AMF propagates the trace control and configuration parameters to a Session Management Function (SMF).

Example 27 may include the method of example 26 and/or some other example herein, wherein the SMF activates Quality of Service (QOS) monitoring for a User Equipment (UE), Packet Data Unit (PDU) session, and QoS flow to be measured.

Example 28 may include the method of example 27 and/or some other example herein, wherein the SMF receives the request to activate QoS monitoring from a Policy Control Function (PCF).

Example 29 may include the method of example 27 and/or some other example herein, wherein the SMF receives the request to activate QoS monitoring from a management function.

Example 30 may include the method of example 27 and/or some other example herein, wherein the SMF propagates the trace control and configuration parameters to a UPF.

Example 31 may include the method of example 30 and/or some other example herein, wherein the UPF starts a Trace Session.

Example 32 may include the method of example 31 and/or some other example herein, wherein the UPF produces the measurements and optionally starts a Trace Recording Session.

Example 33 may include the method of example 32 and/or some other example herein, wherein the UPF reports the produced measurements to the TCE.

Example 34 may include an apparatus comprising means for: receiving a request from a consumer to create a Trace job for collecting delay-related measurements from a User Plane Function (UPF); requesting a Unified Data Management (UDM) system to create the Trace job; receiving a response about a result of the Trace job creation from the UDM; and sending a response indicating the result of the Trace job creation to the consumer.

Example 35 may include the apparatus of example 34 and/or some other example herein, wherein the Trace job may include at least one trace control and configuration parameter selected from the group consisting of a Subscription Permanent Identifier (SUPI), International Mobile Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

Example 36 may include the apparatus of example 34 and/or some other example herein, the UDM propagates the trace control and configuration parameters to an Access and Mobility Management Function (AMF).

Example 37 may include the apparatus of example 36 and/or some other example herein, wherein the AMF propagates the trace control and configuration parameters to a Session Management Function (SMF).

Example 38 may include the apparatus of example 37 and/or some other example herein, wherein the SMF activates Quality of Service (QOS) monitoring for a User Equipment (UE), Packet Data Unit (PDU) session, and QoS flow to be measured.

Example 39 may include the apparatus of example 38 and/or some other example herein, wherein the SMF receives the request to activate QoS monitoring from a Policy Control Function (PCF).

Example 40 may include the apparatus of example 38 and/or some other example herein, wherein the SMF receives the request to activate QoS monitoring from a management function.

Example 41 may include the apparatus of example 38 and/or some other example herein, wherein the SMF propagates the trace control and configuration parameters to a UPF.

Example 42 may include the apparatus of example 41 and/or some other example herein, wherein the UPF starts a Trace Session.

Example 43 may include the apparatus of example 42 and/or some other example herein, wherein the UPF produces the measurements and optionally starts a Trace Recording Session.

Example 44 may include the apparatus of example 43 and/or some other example herein, wherein the UPF reports the produced measurements to the TCE.

Example 45 may include one or more non-transitory computer-readable media comprising instructions to cause an electronic device, upon execution of the instructions by one or more processors of the electronic device, to perform one or more elements of a method described in or related to any of examples 1-44, or any other method or process described herein.

Example 46 may include an apparatus comprising logic, modules, and/or circuitry to perform one or more elements of a method described in or related to any of examples 1-44, or any other method or process described herein.

Example 47 may include a method, technique, or process as described in or related to any of examples 1-44, or portions or parts thereof.

Example 48 may include an apparatus comprising: one or more processors and one or more computer readable media comprising instructions that, when executed by the one or more processors, cause the one or more processors to perform the method, techniques, or process as described in or related to any of examples 1-44, or portions thereof.

Example 49 may include a method of communicating in a wireless network as shown and described herein.

Example 50 may include a system for providing wireless communication as shown and described herein.

Example 51 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “subsystem”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [6], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=” attribute Value “>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiM12), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering.

The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO

The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “O1” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance.

This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over O1.

Furthermore, any of the disclosed embodiments and example implementations can be embodied in the form of various types of hardware, software, firmware, middleware, or combinations thereof, including in the form of control logic, and using such hardware or software in a modular or integrated manner. Additionally, any of the software components or functions described herein can be implemented as software, program code, script, instructions, etc., operable to be executed by processor circuitry. These components, functions, programs, etc., can be developed using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), EMCAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Synt12 Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, and/or any other programming language or development tools including proprietary programming languages and/or development tools. The software code can be stored as a computer- or processor-executable instructions or commands on a physical non-transitory computer-readable medium. Examples of suitable media include RAM, ROM, magnetic media such as a hard-drive or a floppy disk, or an optical medium such as a compact disk (CD) or DVD (digital versatile disk), flash memory, and the like, or any combination of such storage or transmission devices.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

TABLE 1
Abbreviations:

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate M12imum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access |
| | Point |
| API | Application Programming |
| | Interface |
| APN | Access Point Name |
| ARP | Allocation and Retention |
| | Priority |
| ARQ | Automatic Repeat |
| | Request |
| AS | Access Stratum |
| ASP | Application Service |
| | Provider |
| ASN.1 | Abstract Synt12 Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital Expenditure |
| CBRA | Contention Based |
| | Random Access |
| CC | Component Carrier, |
| | Country Code, |
| | Cryptographic Checksum |
| CCA | Clear Channel |
| | Assessment |
| CCE | Control Channel Element |
| CCCH | Common Control |
| | Channel |
| CE | Coverage Enhancement |
| CDM | Content Delivery |
| | Network |
| CDMA | Code-Division Multiple |
| | Access |
| CFRA | Contention Free Random |
| | Access |
| CG | Cell Group |
| CGF | Charging Gateway |
| | Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection |
| | Management, |
| | Conditional Mandatory |
| CMAS | Commercial Mobile Alert |
| | Service |
| CMD | Command |
| CMS | Cloud Management |
| | System |
| CO | Conditional Optional |
| COMP | Coordinated Multi-Point |
| CORESET | Control Resource Set |
| COTS | Commercial Off-The- |
| | Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality |
| | Indicator |
| CPU | CSI processing unit, |
| | Central Processing Unit |
| C/R | Command/Response |
| | field bit |
| CRAN | Cloud Radio Access |
| | Network, Cloud RAN |
| CRB | Common Resource Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise |
| | and interference ratio |
| CSMA | Carrier Sense Multiple |
| | Access |
| CSMA/CA | CSMA with collision |
| | avoidance |
| CSS | Common Search Space, |
| | Cell-specific Search |
| | Space |
| CTF | Charging Trigger |
| | Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, | DMRS Demodulation |
| | Reference Signal |
| DN | Data network |
| DNN | Data Network Name |
| DNAI | Data Network Access |
| | Identifier |
| DRB | Data Radio Bearer |
| DRS | Discovery Reference |
| | Signal |
| DRX | Discontinuous Reception |
| DSL | Domain Specific |
| | Language. Digital |
| | Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration |
| | Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | tableManagement |
| | Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, |
| | enhanced resource |
| | element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane |
| | interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CUg | NB-centralized unit, |
| | Next Generation NodeB |
| | centralized unit |
| gNB-DUg | NB-distributed unit, |
| | Next Generation NodeB |
| | distributed unit |
| GNSS | Global Navigation |
| | Satellite System |
| GPRS | General Packet Radio |
| | Service |
| GPSI | Generic Public |
| | Subscription Identifier |
| GSM | Global System for Mobile |
| | Communications, |
| | Groupe Spécial Mobile |
| GTP | GPRS Tunneling Protocol |
| GTP-U | GPRS Tunnelling |
| | Protocol for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat |
| | Request |
| HANDO | Handover |
| HFN | HyperFrame Number |
| HHO | Hard Handover |
| HLR | Home Location Register |
| HN | Home Network |
| HO | Handover |
| HPLMN | Home Public Land |
| | Mobile Network |
| HSDPA | High Speed Downlink |
| | Packet Access |
| HSN | Hopping Sequence |
| | Number |
| HSPA | High Speed Packet |
| | Access |
| HSS | Home Subscriber Server |
| HSUPA | High Speed Uplink |
| | Packet Access |
| HTTP | Hyper Text Transfer |
| | Protocol |
| HTTPS | Hyper Text Transfer |
| | Protocol Secure (https is |
| | http/1.1 over SSL, i.e. |
| | port 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of |
| | Electrical and |
| | Electronics |
| | Engineers |
| IEI | Information |
| | Element Identifier |
| IEIDL | Information |
| | Element Identifier |
| | Data Length |
| IETF | Internet |
| | Engineering Task |
| | Force |
| IF | Infrastructure |
| IM | Interference |
| | Measurement, |
| | Intermodulation, IP |
| | Multimedia |
| IMC | IMS Credentials |
| IMEI | International |
| | Mobile Equipment |
| | Identity |
| IMGI | International |
| | mobile group |
| | identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile Subscriber |
| | Identity |
| IoT | Internet of Things |
| IP | Internet Protocol |
| Ipsec | IP Security, |
| | Internet Protocol |
| | Security |
| IP-CAN | IP-Connectivity |
| | Access Network |
| | IP-M IP Multicast |
| IPv4 | Internet Protocol |
| | Version 4 |
| IPV6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking- |
| | Function |
| I-WLAN | Interworking WLAN |
| | Constraint length of |
| | the convolutional code, |
| | USIM Individual key |
| kB | Kilobyte (1000 |
| | bytes) |
| kbps | kilo-bits per second |
| Kc | Ciphering key |
| Ki | Individual |
| | subscriber |
| | authentication key |
| KPI | Key Performance |
| | Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 |
| | reference signal |
| | received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link |
| | Control, Low Layer |
| | Compatibility |
| LPLMN | Local PLMN |
| LPP | LTE Positioning |
| | Protocol |
| LSB | Least Significant Bit |
| LTE | Long Term |
| | Evolution |
| LWA | LTE-WLAN |
| | aggregation |
| LWIP | LTE/WLAN Radio |
| | Level Integration |
| | with IPsec Tunnel |
| LTE | Long Term |
| | Evolution |
| M2M | Machine-to- |
| | Machine |
| MAC | Medium Access |
| | Control (protocol |
| | layering context) |
| MAC | Message |
| | authentication code |
| | (security/encryption |
| | context) |
| MAC-A | MAC used for |
| | authentication and |
| | key agreement |
| | (TSG T WG3 |
| | context) |
| MAC-I | MAC used for data |
| | integrity of |
| | signalling messages |
| | (TSG T WG3 |
| | context) |
| MANO | Management and |
| | Orchestration |
| MBMS | Multimedia |
| | Broadcast and |
| | Multicast Service |
| MBSFN | Multimedia |
| | Broadcast multicast |
| | service Single |
| | Frequency Network |
| MCC | Mobile Country |
| | Code |
| MCG | Master Cell Group |
| MCOT | M12imum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error |
| | Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility |
| | Management |
| MME | Mobility |
| | Management Entity |
| MN | Master Node |
| MNO | Mobile Network |
| | Operator |
| MO | Measurement |
| | Object, Mobile |
| | Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical |
| | Random Access |
| | CHannel |
| MPUSCH | MTC Physical |
| | Uplink Shared |
| | Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| | MSID Mobile Station |
| | Identifier |
| MSIN | Mobile Station |
| | Identification |
| | Number |
| MSISDN | Mobile |
| | Subscriber ISDN |
| | Number |
| MT | Mobile Terminated, |
| | Mobile Termination |
| MTC | Machine-Type |
| | Communications |
| mMTC | massive MTC, |
| | massive Machine- |
| | Type |
| | Communications |
| MU-MIMO | Multi User MIMO |
| MWUS | MTC wake-up |
| | signal, MTC WUS |
| NACK | Negative |
| | Acknowledgement |
| NAI | Network Access |
| | Identifier |
| NAS | Non-Access |
| | Stratum, Non- |
| | Access Stratum |
| | layer |
| NCT | Network |
| | Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network |
| | Network Forwarding Path |
| NFPD | Network |
| | Forwarding Path |
| | Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN E-UTRA- |
| | NR Dual |
| | Connectivity |
| NM | Network Manager |
| NMS | Network |
| | Management |
| | System |
| N-PoP | Network Point of |
| | Presence |
| NMIB, N-MIB | Narrowband |
| | MIB |
| NPBCH | Narrowband |
| | Physical Broadcast |
| | CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone operation mode |
| NSD | Network Service |
| | Descriptor |
| NSR | Network Service |
| | Record |
| NSSAI | Network Slice |
| | Selection |
| | Assistance |
| | Information |
| S-NNSAI | Single-NSSAI |
| NSSF | Network Slice |
| | Selection Function |
| NW | Network |
| NWUS | Narrowband wake- |
| | up signal, |
| | Narrowband WUS |
| NZP | Non-Zero Power |
| O&M | Operation and |
| | Maintenance |
| ODU2 | Optical channel |
| | Data Unit - type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average |
| | Ratio |
| PBCH | Physical Broadcast |
| | Channel |
| PC | Power Control, |
| | Personal Computer |
| PCC | Primary Component |
| | Carrier, Primary CC |
| PCell | Primary Cell |
| PCI | Physical Cell ID, |
| | Physical Cell |
| | Identity |
| PCEF | Policy and Charging |
| | Enforcement |
| | Function |
| PCF | Policy Control |
| | Function |
| PCRFPolicy | Control and |
| | Charging Rules |
| | Function |
| PDCP | Packet Data |
| | Convergence |
| | Protocol, Packet |
| | Data Convergence |
| | Protocol layer |
| PDCCH | Physical Downlink |
| | Control Channel |
| PDCP | Packet Data |
| | Convergence |
| | Protocol |
| PDN | Packet Data |
| | Network, Public |
| | Data Network |
| PDSCH | Physical Downlink |
| | Shared Channel |
| PDU | Protocol Data Unit |
| PEI | Permanent |
| | Equipment |
| | Identifiers |
| PFD | Packet Flow |
| | Description |
| P-GW | PDN Gateway |
| PHICH | Physical hybrid- |
| | ARQ indicator |
| | channel |
| PHY | Physical layer |
| PLMN | Public Land Mobile |
| | Network |
| PIN | Personal |
| | Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point |
| | Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning |
| | Reference Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink |
| | Shared Channel |
| QAM | Quadrature |
| | Amplitude Modulation |
| QCI | QoS class of identifier |
| QCL | Quasi co-location |
| QFI | QoS Flow ID, Qos |
| | Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access |
| | RNTI |
| RAB | Radio Access Bearer, |
| | Random Access Burst |
| RACH | Random Access |
| | Channel |
| RADIUS | Remote |
| | Authentication Dial In |
| | User Service |
| RAN | Radio Access |
| | Network |
| RAND | RANDom number |
| | (used for |
| | authentication) |
| RAR | Random Access |
| | Response |
| RAT | Radio Access |
| | Technology |
| RAU | Routing Area Update |
| RB | Resource block, |
| | Radio Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC | AM RLC Acknowledged |
| | Mode |
| RLC | UM RLC |
| | Unacknowledged |
| | Mode |
| RLF | Radio Link Failure |
| RLM | Radio Link Monitoring |
| RLM-RS | Reference |
| | Signal for RLM |
| RM | Registration |
| | Management |
| RMC | Reference |
| | Measurement |
| | Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MMES1 | for the control |
| | plane |
| S1-U | S1 for the user plane |
| S-GW | Serving Gateway |
| S-RNTI | SRNC Radio Network |
| | Temporary Identity |
| S-TMSI | SAE Temporary |
| | Mobile Station |
| | Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary |
| | Component Carrier, |
| | Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation Protocol |
| | layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency |
| | Time Diversity, SFN |
| | and frame timing |
| | difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization |
| | Signal |
| SSB | Synchronization |
| | Signal Block |
| SSID | Service Set Identifier |
| SS/PBCH | Block |
| SSBRI | SS/PBCH Block |
| | Resource Indicator, |
| | Synchronization |
| | Signal Block Resource |
| | Indicator |
| SSC | Session and Service |
| | Continuity |
| SS-RSRP | Synchronization |
| | Signal based |
| | Reference Signal |
| | Received Power |
| SS-RSRQ | Synchronization |
| | Signal based |
| | Reference Signal |
| | Received Quality |
| SS-SINR | Synchronization |
| | Signal based Signal |
| | to Noise and |
| | Interference Ratio |
| SSS | Secondary |
| | Synchronization |
| | Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance |
| | Group |
| TAI | Tracking Area |
| | Identity |
| TAU | Tracking Area Update |
| TB | Transport Block |
| TBS | Transport Block Size |
| TBD | To Be Defined |
| TCI | Transmission |
| | Configuration |
| | Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitted |
| | Precoding Matrix |
| | Indicator |
| TR | Technical Report |
| TRP, TRXP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and |
| | Low Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access |
| | Network |
| UwPTS | Uplink Pilot Time Slot |
| V2I | Vehicle-to- |
| | Infrastruction |
| V2P | Vehicle-to-Pedestrian |
| V2V | Vehicle-to-Vehicle |
| V2X | Vehicle-to-everything |
| VIM | Virtualized |
| | Infrastructure |
| | Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding |
| | Graph |
| VNFFGD | VNF Forwarding |
| | Graph Descriptor |
| VNFM | VNF Manager |
| VoIP | Voice-over-IP, Voice- |
| | over-Internet |
| | Protocol |
| VPLMN | Visited Public Land |
| | Mobile Network |
| VPN | Virtual Private |
| | Network |
| VRB | Virtual Resource |
| | Block |
| WiM12 | Worldwide |
| | Interoperability for |
| | Microwave Access |
| WLAN | Wireless Local Area |
| | Network |
| WMAN | Wireless Metropolitan |
| | Area Network |
| WPAN | Wireless Personal |
| | Area Network |
| X2-C | X2-Control plane |
| X2-U | X2-User plane |
| XML | extensible Markup |
| | Language |
| XRES | EXpected user |
| | RESponse |
| XOR | eXclusive OR |
| ZC | Zadoff-Chu |
| ZP | Zero Po |

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

What is claimed is:

1. An apparatus, the apparatus comprising processing circuitry coupled to storage, the processing circuitry configured to:
receive a request from a consumer to create a Trace job for collecting delay-related measurements from a User Plane Function (UPF);
request a Unified Data Management (UDM) system to create the Trace job;
receive a response about a result of the Trace job creation from the UDM; and
send a response indicating the result of the Trace job creation to the consumer.

2. The apparatus of claim 1, wherein the Trace job includes at least one trace control and configuration parameter selected from the group consisting of a Subscription Permanent Identifier (SUPI), International Mobile Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

3. The apparatus of claim 1, the UDM propagates the trace control and configuration parameters to an Access and Mobility Management Function (AMF).

4. The apparatus of claim 3, wherein the AMF propagates the trace control and configuration parameters to a Session Management Function (SMF).

5. The apparatus of claim 4, wherein the SMF activates Quality of Service (QOS) monitoring for a User Equipment (UE), Packet Data Unit (PDU) session, and QoS flow to be measured.

6. The apparatus of claim 5, wherein the SMF receives the request to activate QoS monitoring from a Policy Control Function (PCF).

7. The apparatus of claim 5, wherein the SMF receives the request to activate QoS monitoring from a management function.

8. The apparatus of claim 5, wherein the SMF propagates the trace control and configuration parameters to a UPF.

9. The apparatus of claim 8, wherein the UPF starts a Trace Session.

10. The apparatus of claim 9, wherein the UPF produces the measurements and optionally starts a Trace Recording Session.

11. The apparatus of claim 10, wherein the UPF reports the produced measurements to the TCE.

12. A non-transitory computer-readable medium storing computer-executable instructions which when executed by one or more processors result in performing operations comprising:
receiving a request from a consumer to create a Trace job for collecting delay-related measurements from a User Plane Function (UPF);
requesting a Unified Data Management (UDM) system to create the Trace job;
receiving a response about a result of the Trace job creation from the UDM; and
sending a response indicating the result of the Trace job creation to the consumer.

13. The non-transitory computer-readable medium of claim 12, wherein the Trace job includes at least one trace control and configuration parameter selected from the group consisting of a Subscription Permanent Identifier (SUPI), International Mobile Equipment Identity Software Version (IMEISV), Session ID, Quality of Service (QOS) Flow Identifier, Trace Reference, a list of Network Element (NE) types to trace, a list of measurements, Report Interval, IP address of Trace Collection Entity (TCE), URI of the Trace Reporting Management Service (MnS) consumer, or Trace reporting format.

14. The non-transitory computer-readable medium of claim 12, the UDM propagates the trace control and configuration parameters to an Access and Mobility Management Function (AMF).

15. The non-transitory computer-readable medium of claim 14, wherein the AMF propagates the trace control and configuration parameters to a Session Management Function (SMF).

16. The non-transitory computer-readable medium of claim 15, wherein the SMF activates Quality of Service (QOS) monitoring for a User Equipment (UE), Packet Data Unit (PDU) session, and QoS flow to be measured.

17. The non-transitory computer-readable medium of claim 16, wherein the SMF receives the request to activate QoS monitoring from a Policy Control Function (PCF).

18. The non-transitory computer-readable medium of claim 16, wherein the SMF receives the request to activate QoS monitoring from a management function.

19. The non-transitory computer-readable medium of claim 16, wherein the SMF propagates the trace control and configuration parameters to a UPF.

20. A method comprising:
receiving a request from a consumer to create a Trace job for collecting delay-related measurements from a User Plane Function (UPF);
requesting a Unified Data Management (UDM) system to create the Trace job;
receiving a response about a result of the Trace job creation from the UDM; and
sending a response indicating the result of the Trace job creation to the consumer.
